(19) United States
(12) Patent Application Publication
(10) Pub. No.: US 2011/0310413 A1
(43) Pub. Date: Dec. 22, 2011

(54) IMAGE PROCESSING APPARATUS PERFORMING POWER-SAVING OPERATION

(75) Inventor: Takehisa NAKAO, Toyokawa-shi (JP)

(73) Assignee: Konica Minolta Business Technologies, Inc., Chiyoda-ku (JP)

(21) Appl. No.: 13/164,034

(22) Filed: Jun. 20, 2011

(30) Foreign Application Priority Data
Jun. 22, 2010 (JP) 2010-141583

(51) Int. Cl. G06F 15/00

(52) U.S. Cl. 358/1.9

(57) ABSTRACT

An image processing apparatus includes a CPU, a memory, and a bus connecting the CPU and the memory, and performs a process for printing print data. The image processing apparatus includes an input unit for inputting print data from an external device, a conversion unit for converting print data into raster data, and a measuring unit for measuring a time required for conversion in the conversion unit. Measurement is performed by the measuring unit, and based on the measurement result, the setting for slowing down the speed of conversion processing in the conversion unit is made (for example, the setting for reducing at least one of the operating frequency of the CPU, the power supply voltage of the CPU, and the operating frequency of the bus). Thus, an effective power saving process can be performed.

This application is based on Japanese Patent Application No. 2010-141583 filed with the Japan Patent Office on Jun. 22, 2010, the entire content of which is hereby incorporated by reference.

### BACKGROUND OF THE INVENTION

1. Field of the Invention

The present invention relates to an image processing apparatus, and more particularly to an image processing apparatus performing a process of converting print data into raster data.

2. Description of the Related Art

Electrophotographic image forming apparatuses include, for example, MFPs (Multi Function Peripherals) having a scanner function, a facsimile function, a copy function, a printer function, a data communication function, and a server function, facsimile machines, copiers, and printers. One of the functions of image forming apparatuses is to convert print data into raster data and to form an image on paper based on the raster data.

More specifically, an image forming apparatus has an image processing apparatus. The image processing apparatus converts print data received (input) from a PC (Personal Computer) into raster data. Such a conversion process is called a RIP (Raster Image Processing) process. The image forming apparatus prints the raster data converted through the RIP process. The print data is described in PDL (Page Description Language). PDL includes, for example, PostScript (PS), PDF (Portable Document Format), PCL (Printer Control Language), and XPS (XML Paper Specification).

Document 1 below discloses an image input/output apparatus including a reader unit scanning a document image and outputting image data corresponding to the document image and a printer unit recording an image corresponding to the image data on recording paper. The image input/output apparatus does not cancel the power saving mode for a device unnecessary to execute a job requested in the power saving mode. Specifically, when the image input/output apparatus is requested to execute a job, at first, a power control unit supplies power to a system excluding the reader unit and the printer unit. Then, based on the content of the job, power is selectively supplied to the reader unit and the printer unit.

Document 2 below discloses an image forming apparatus including a CPU (Central Processing Unit) and an ASIC (Application Specific Integrated Circuit). Printing is done with the reduced clock frequency and driving current of the CPU and the ASIC, in a power saving mode, during hours when the printer utilization rate is low (for example, at midnight), and at the time of time-designated printing that does not require a high print speed. Power saving is thus achieved.

Document 3 below discloses an image forming apparatus having a high-speed print mode. When the high-speed print mode is selected, the performance is enhanced by increasing the clock frequency in a printing process. While the performance is enhanced, power supply to components that are not involved in the printing process is cut off. As a result, total power consumption is reduced.

Document 1: Japanese Laid-Open Patent Publication No. 2000-125057

Document 2: Japanese Laid-Open Patent Publication No. 2002-86844

Document 3: Japanese Laid-Open Patent Publication No. 2006-289917

As described above, power saving in an image forming apparatus is achieved in two ways: stopping power supply to an unnecessary part; and reducing the clock frequency and driving current of CPU and ASIC. Documents 1 and 3 above disclose stopping power supply to an unnecessary part. Document 2 discloses reducing the clock frequency and driving current of CPU and ASIC.

It has been proposed that the clock frequency and the driving current of CPU and ASIC are reduced when printing is not done, for example, on standby or in a sleep mode or when a low print speed is permitted, for example, in time-designated printing at midnight, as shown in Document 2 above. However, a print speed is a high priority during a time of day when prompt print distribution is desired, for example, during the busy day time hours. Therefore, generally, the process of reducing the clock frequency and the driving current is not performed during the busy day time hours except when the apparatus is on standby or in a sleep mode. Accordingly, a reduction in print speed is prevented when the print speed is a high priority. Meanwhile, however, the degree of power saving is low during the busy day time hours.

### SUMMARY OF THE INVENTION

The prevent invention therefore aims to provide an image processing apparatus capable of an effective power saving process.

In order to achieve the aforementioned object, in accordance with an aspect of the present invention, an image processing apparatus includes: an input unit for inputting print data; a conversion unit for converting the print data into raster data; a measuring unit for measuring a time required for conversion in the conversion unit; and a setting unit for making setting for slowing down a speed of conversion processing in the conversion unit, based on a measurement result obtained by the measuring unit.

In accordance with another aspect of the present invention, an image processing apparatus includes: an input unit for inputting print data; a processor for executing a process of converting the print data into intermediate data and a process of converting the intermediate data into raster data; a memory for storing the intermediate data converted by the processor; a bus for transferring data between the processor and the memory; a measuring unit for measuring a proportion of printing area in the print data; and a setting unit for making setting for reducing an operating frequency of the bus, based on a measurement result obtained by the measuring unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an image forming apparatus in a first embodiment of the present invention.

FIG. 2 is a block diagram functionally showing components of the image forming apparatus in FIG. 1.

FIG. 3 is a block diagram showing a hardware configuration of a controller unit 150 in FIG. 2.

FIG. 4 is a block diagram showing a configuration functionally implemented by a CPU 201 in FIG. 3.

FIG. 5 shows a configuration of a RIP process unit 201d in FIG. 4.

FIG. 6 shows the relation between the time required for a RIP process and the time required for the subsequent printing process.

FIG. 7 is a flowchart of the printing process including power saving control executed by CPU 201 of controller unit 150.

FIG. 8 specifically shows the longest possible time available for the RIP process in the image forming apparatus capable of printing 60 sheets in 60 seconds.

FIG. 9 shows a specific example of a comparison table for performing frequency change control.

FIG. 10 shows an example in which operating frequencies are switched based on the table in FIG. 9.

FIG. 11 is a flowchart of the printing process including power saving control executed by the image forming apparatus in a second embodiment of the present invention.

FIG. 12 is a timing chart schematically showing a first process executed by the image forming apparatus in the second embodiment of the present invention.

FIG. 13 shows a specific example of a power saving effect achieved by controller unit 150 when the process in FIG. 12 is performed.

FIG. 14 is a timing chart schematically showing a second process executed by the image forming apparatus in the second embodiment of the present invention.

FIG. 15 shows a specific example of a power saving effect achieved by controller unit 150 when the process in FIG. 14 is performed.

FIG. 16 is a timing chart schematically showing a third process executed by the image forming apparatus in the second embodiment of the present invention.

FIG. 17 shows a specific example of a power saving effect achieved by controller unit 150 when the process in FIG. 16 is performed.

FIG. 18 is a flowchart showing an operation of CPU 201 of the image forming apparatus in a third embodiment.

### DESCRIPTION OF THE PREFERRED EMBODIMENTS

In the following, an image forming apparatus in embodiments of the present invention will be described.

An image forming apparatus can print an image on paper based on print data by electrophotography. The image forming apparatus is a tandem-type apparatus capable of forming a color image by combining four color images of CMYK (cyan, magenta, yellow, and black).

The image forming apparatus in the present embodiment can execute a power saving process more effectively by reducing a clock frequency and voltage while minimizing the effect on the print speed (or without affecting the print speed).

### First Embodiment

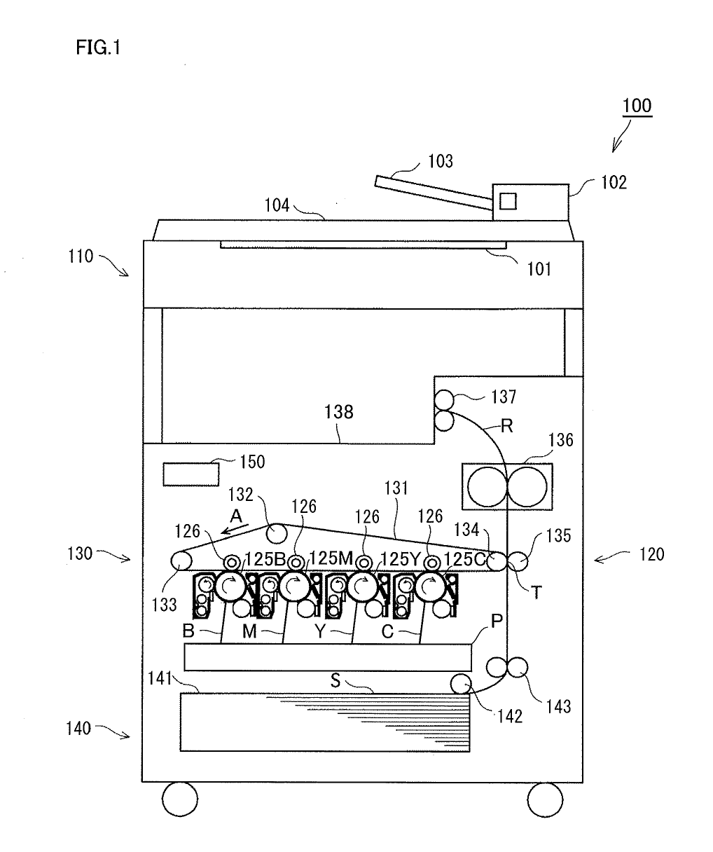

FIG. 1 shows an image forming apparatus in a first embodiment of the present invention. The image forming apparatus in the present embodiment is an MFP (Multi Function Peripheral) including a scanner function, a facsimile function, a copy function, a printer function, a data communication function, and a server function. The image forming apparatus may be, for example, a facsimile machine, a copier, or a printer.

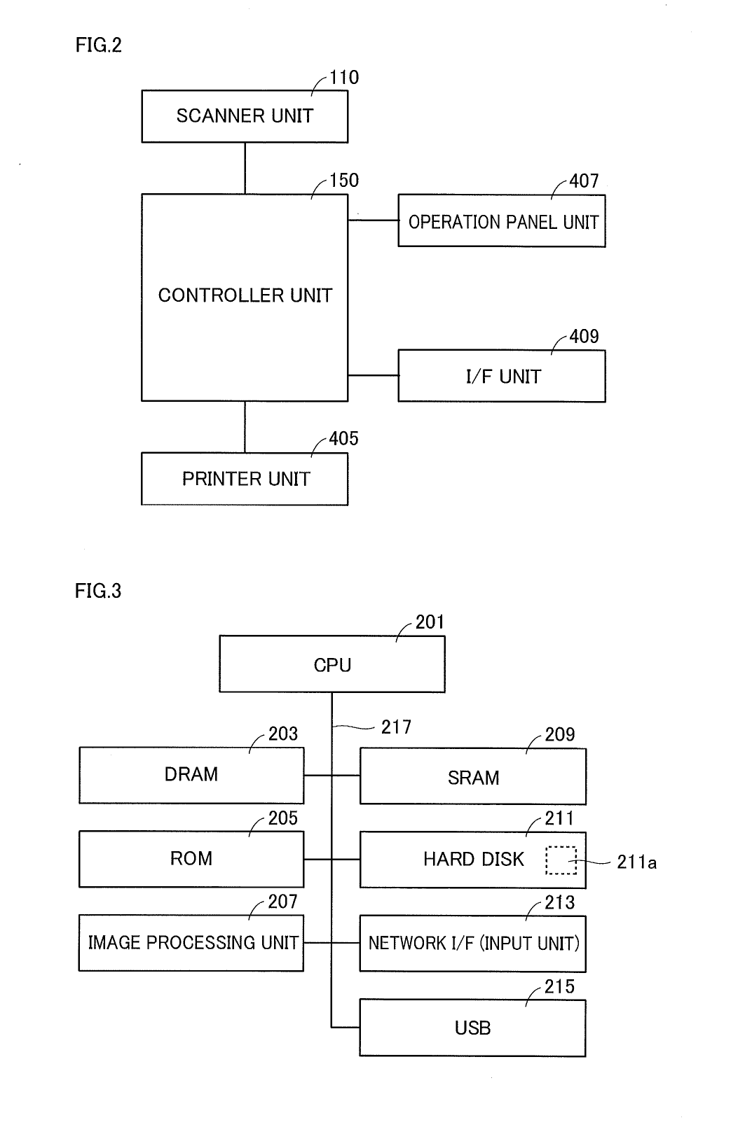

First, referring to FIG. 1, an image forming apparatus 100 mainly includes a scanner unit 110, a transfer unit 120, a development unit 130, and a paper feeding unit 140. Scanner unit 110 is provided in the upper portion of the apparatus. Transfer unit 120 is provided to the lower right of scanner unit 110. Development unit 130 is provided to the lower left of scanner unit 110. Paper feeding unit 140 is provided below transfer unit 120 and development unit 130. Transfer unit 120, development unit 130, and paper feeding unit 140 constitute a printer unit 405 (FIG. 2) in which an electrostatic latent image is formed on a photoconductor and developed by toner, and the developed toner image is transferred through an intermediate transfer belt onto paper.

Scanner unit 110 is a unit for scanning an image from a document and includes a document glass 101, an automatic document feeder (ADF) 102, a document tray 103, and a document discharge tray 104. ADF 102, document tray 103, and document discharge tray 104 are arranged above document glass 101. A document placed on document tray 103 is conveyed from ADF 102 onto document glass 101, and an image is scanned on document glass 101. After an image is scanned on document glass 101, the document is discharged to document discharge tray 104.

Transfer unit 120 is a unit for transferring a toner image on an intermediate transfer belt 131 to paper and discharging the paper and includes a secondary transfer roller 135, a fixing device 136, a paper exit roller 137, and a paper exit unit 138. Fixing device 136 is arranged downstream of secondary transfer roller 135 in a paper conveyance path R, and paper exit roller 137 is arranged downstream of fixing device 136 in paper conveyance path R. A toner image is transferred to paper conveyed from paper feeding unit 140 at a nip portion T using secondary transfer roller 135. The toner image is a toner image on intermediate transfer belt 131. The paper is then sent to fixing device 136, which fixes the transferred image using a heating roller and the like. The paper having the fixed toner image is sent to paper exit roller 137 and discharged to paper exit unit 138.

Development unit 130 is a unit for forming a toner image on intermediate transfer belt 131 and includes an optics P as a scanner, intermediate transfer belt 131, rollers 132-134, photoconductor drums 125B, 125M, 125Y, 125C, and a plurality of primary transfer rollers 126. Optics P includes scanners corresponding to black (B (or also denoted by K), magenta (M), yellow (Y), and cyan (C). Each of photoconductor drums 125B, 125M, 125Y, 125C is rotated and is located under intermediate transfer belt 131 such that intermediate transfer belt 131 is sandwiched between each photoconductor drum and primary transfer roller 126. Optics P is arranged under intermediate transfer belt 131. The scanners of optics P emit light beams B, M, Y, C corresponding to gray scale information obtained based on the scanned image, to photoconductor drums 125B, 125M, 125Y, 125C, respectively. Accordingly, a latent image is formed on each surface of photoconductor drums 125B, 125M, 125Y, 125C, and a toner image is formed based on the latent image. Intermediate transfer belt 131 is driven by rollers 132-134 in the direction shown by arrow A in FIG. 1. The toner image on each surface of photoconductor drums 125B, 125M, 125Y, 125C is transferred to intermediate transfer belt 131 whereby the toner image is formed on intermediate transfer belt 131.

Paper feeding unit 140 is a unit for supplying paper to secondary transfer roller 135 and includes a paper tray 141, a paper feeding roller 142, and a paper conveyance roller 143. A required number of sheets of paper are supplied from paper tray 141 storing plural sheets of paper S, onto which images are to be formed, to secondary transfer roller 135 using paper feeding roller 142 and paper conveyance roller 143.

Image forming apparatus 100 includes a controller unit (an example of the image processing apparatus) 150 including a CPU (Central Processing Unit), a RAM, a ROM, and the like.

FIG. 2 is a block diagram functionally showing components of the image forming apparatus in FIG. 1.

Referring to the figure, the image forming apparatus includes scanner unit 110 for scanning image data from a document, controller unit 150 performing the entire control of the apparatus, printer unit 405 for forming a toner image on paper, an operation panel 407 for displaying a state of the apparatus to the user and accepting input for operating the apparatus, and an interface (I/F) unit 409 for transmitting and receiving information to/from external equipment.

FIG. 3 is a block diagram showing a hardware configuration of controller unit 150 in FIG. 2.

Referring to the figure, controller unit 150 includes a central processing unit (CPU, an example of the processing apparatus) 201, a DRAM 203 and an SRAM 209, which constitute a storage area (memory area), a ROM 205 and a hard disk 211 for storing a program for causing the apparatus to operate, an image processing unit 207 performing processing of images, a network interface 213 for communicating with an external network, and a USB port 215 for communicating with external equipment. Network interface 213 forms an input unit receiving print data from an external device (PC).

Controller unit 150 may be configured to include a circuit board including central processing unit (CPU) 201, DRAM 203 and SRAM 209, ROM 205, image processing unit 207, a control circuit of network interface 213, and a control circuit of USB port 215. Part of controller unit 150 (for example, the image processing unit) may be formed of an ASIC (Application Specific Integrated Circuit).

Here, hard disk 211 stores a program 211a.

The hardware components included in controller unit 150 are connected through a bus 217. The operating frequency, which is a transmission speed of the bus, is controlled by CPU 201.

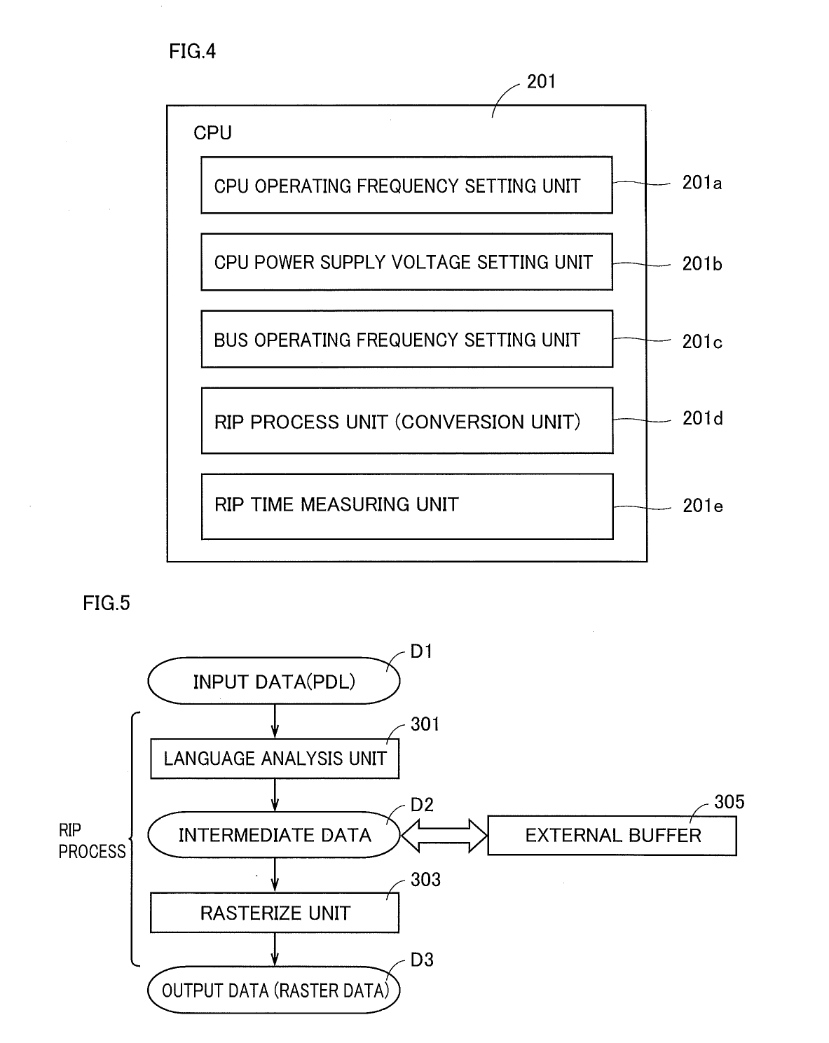

FIG. 4 is a block diagram showing a configuration functionally implemented by CPU 201 in FIG. 3.

Referring to the figure, CPU 201 includes a CPU operating frequency setting unit 201a capable of setting an operating frequency of the CPU, a CPU power supply voltage setting unit 201b capable of setting a power supply voltage of the CPU, a bus operating frequency setting unit 201c capable of setting an operating frequency of the bus, which connects the components of controller 150 (for example, connecting CPU 201, image processing unit 207, and the memory such as DRAM 203 with each other), and an RIP process unit 201d performing an RIP (Raster Image Processing) process (RIP expansion) of print data. RIP process unit 201d forms a conversion unit converting print data from an external device into raster data.

CPU 201 also includes an RIP time measuring unit 201e measuring the conversion time in RIP process unit 201d.

CPU 201 uses these components to perform the RIP process on print data. CPU 201 can reduce the operating frequency of the CPU and can reduce the power supply voltage of the CPU. Furthermore, CPU 201 can reduce the operating frequency of the bus (also called a memory bus) for connecting the memory, and the like.

More specifically, CPU 201 performs control such that at least one of the CPU operating frequency, the CPU power supply voltage, and the memory bus operating frequency is reduced. Power consumption in controller unit 150 can be reduced by reducing any of these three elements. Such control of reducing at least one of the CPU operating frequency, the CPU power supply voltage, and the memory bus operating frequency is performed such that the time taken to complete printing is not prolonged even when the control is performed. Accordingly, power consumption can be reduced without delaying the print completion.

FIG. 5 shows a configuration of RIP process unit 201d in FIG. 4.

RIP process unit 201d processes print data input from an external PC and described in PDL (Page Description Language) as input data D1 to create raster data D3 as output data. This is performed in the following manner. Examples of PDL include PostScript (PS), PDF (Portable Document Format), PCL (Printer Control Language), and XPS (XML Paper Specification), although the present invention is not limited to any particular kind.

A language analysis unit 301 processes input data D1 to create intermediate data D2. Intermediate data D2 is temporarily stored into an external buffer 305 connected to CPU 201 through the bus. External buffer 305 is formed of a storage device (memory) such as DRAM 203 or SRAM 209.

A rasterize unit 303 reads out intermediate data D2 from external buffer 305 through the bus. Thereafter, a rasterize process is performed on intermediate data D2. Output data D3 is thus created.

The total time of the time required for the processing performed by language analysis unit 301 and the time required for the processing performed by rasterize unit 303 is the time required for the RIP process.

The speed of the intermediate data D2 creating process executed by language analysis unit 301 is affected by the performance of CPU 201. The performance of CPU 201 varies with the operating frequency and the power supply voltage of CPU 201. The speed of the output data D3 creating process executed by rasterize unit 303 is affected by the operating frequency of the bus.

In the present embodiment, the process of reducing (slowing down) the speed of the RIP process is performed when the speed of the RIP process of a page is so fast that, after raster data is created in rasterize unit 303, there is a sufficient time for the created raster data to wait until printing is started in printer unit 405.

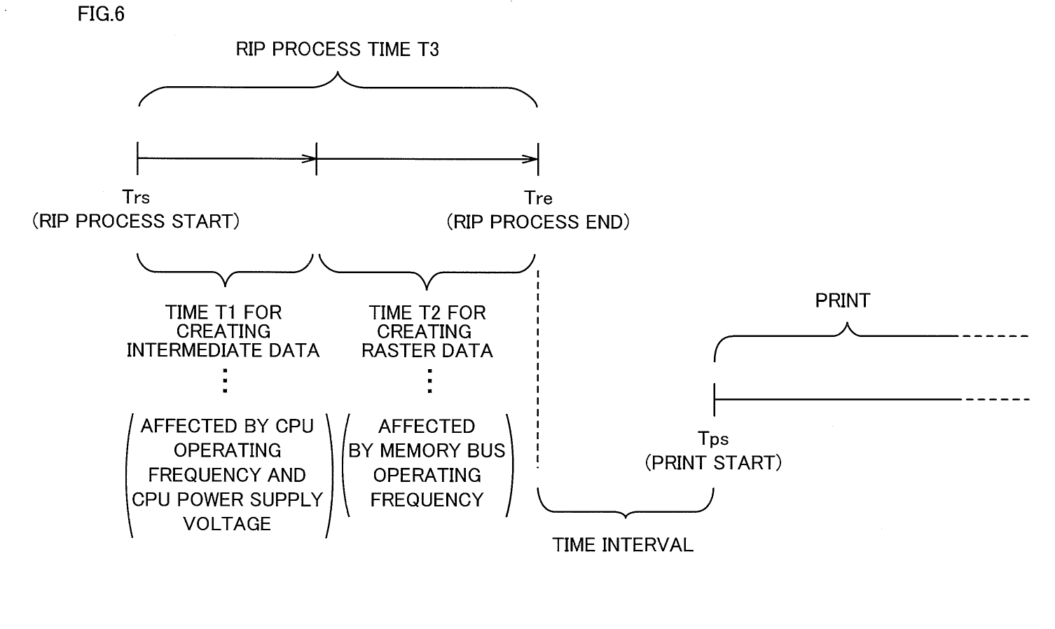

FIG. 6 shows the relation between the time required for the RIP process and the time required for the subsequent printing process.

For the sake of explanation, the time at which the RIP process for data of a certain page of print data is started is denoted by Trs, and the time at which the RIP process ends is denoted by Tre. Tps represents the time at which the RIP process of the data of that page is completed and printing is started by printer unit 405.

Letting T3 be the time required for the RIP process, in which T1 is the time required for creating intermediate data from print data, and T2 is the time required for creating raster data from the intermediate data, then T1+T2=T3 holds.

Here, it is assumed that print data is received when printer unit 405 is on standby. When the RIP process for data of the first page of the print data is finished, printing of the first page is started. Here, printer unit 405 can start printing of the first page immediately after the RIP process ends (the time interval between time Tre and time Tps can be extremely shortened).

The processing in printer unit 405 includes mechanical processing such as driving the photoconductors and the transfer belt, and conveying paper. Therefore, the printing process in printer unit 405 usually takes a time longer than the RIP process performed only by electrical computation. Therefore, in the conventional technique, printing of the first page in printer unit 405 is often not completed when the RIP process for the second page is completed. Therefore, the time interval between time Tre at which the RIP process for the second page is completed and time Tps at which printing of the second page starts is long in the conventional technique.

The time interval between time Tre and time Tps, if any, is a waste and has to be shortened. Specifically, the interval can be shortened by delaying time Tre and/or shortening the time required for the printing process in printer unit 405.

Here, printer unit 405 has mechanical restrictions such as the limitations of the driving speed of the photoconductors or the transfer belt and the limitations of the paper conveyance speed. Therefore, generally, it is difficult to shorten the time required for the printing process, in terms of the mechanical design. Even if the time required for the printing process can be shortened, it does not lead to power saving. Therefore, in the present embodiment, in order to shorten the time interval between time Tre and time Tps, time Tre is delayed by reducing the speed of the RIP process.

More specifically, control is performed such that time Tre at which the RIP process of a certain page is completed is timed to coincide with (or come closer to) time Tps at which printing of that page is started. The speed of the RIP process is reduced by lowering the performance (operating frequency, power supply voltage) of CPU 201 and/or lowering the operating frequency of the memory bus. Accordingly, the power consumption of controller unit 150 of the image processing apparatus during printing can be reduced.

The reduction of power consumption by slowing down the speed of the RIP process will be described below.

The processing speed of a CPU is proportional to the CPU operating frequency. In other words, when the CPU operating frequency is doubled, the CPU processing speed is doubled. When the CPU operating frequency is halved, the CPU processing speed is halved. The time required for the process of converting input data into intermediate data is generally inversely proportional to the CPU operating frequency.

It is assumed that a time interval is expected to occur between time Tre and time Tps in FIG. 6 and that the CPU operating frequency can be reduced to ¼. If the CPU operating frequency is reduced to ¼, time T1 required for creating intermediate data increases. Accordingly, time Tre can be delayed, and the interval between time Tre and time Tps can be shortened. When the CPU operating frequency is reduced to ¼, the CPU power supply voltage can be reduced to ½.

The power consumption of a CPU is proportional to the second power of the power supply voltage×the operating frequency. Therefore, when the CPU operating frequency is reduced to ¼ and the CPU power supply voltage is reduced to ½, the power consumption of the CPU can be reduced to (½×½)×¼= 1/16.

When the CPU operating frequency is reduced to ½, the CPU power supply voltage can be reduced to ¾. When the CPU operating frequency is reduced to ½ and the CPU power supply is reduced to ¾, the power consumption of the CPU can be reduced to (¾×¾)×½= 9/32.

As described above, the RIP process includes the process of converting input data (print data) sent from a PC into intermediate data and the process of converting the intermediate data into raster data. The time required for the process of converting input data into intermediate data is generally proportional to the CPU operating frequency.

On the other hand, the time required for the process of converting intermediate data into raster data is affected by the transfer speed of the memory bus (that is, the operating frequency of the memory bus). This is because the memory bus is used to exchange intermediate data between CPU 201 and external buffer 305 (FIG. 5). Since print data including, for example, a background image is especially large in volume, the time required for converting intermediate data into raster data is strongly affected by the transfer speed of the memory bus. Of course, the time required for the process of converting intermediate data into raster data may also be affected by the CPU operating frequency because print data including a background image is large in volume. However, such a clear correlation as in the relation between the memory bus transfer speed and the time required for the process of converting intermediate data into raster data cannot be found in the relation between the CPU operating frequency and the time required for the process of converting intermediate data into raster data.

In the present embodiment, power consumed in the RIP process is reduced, with attention being paid to the above-noted relation between the CPU processing speed, the transfer speed of the memory bus, and the consumption power.

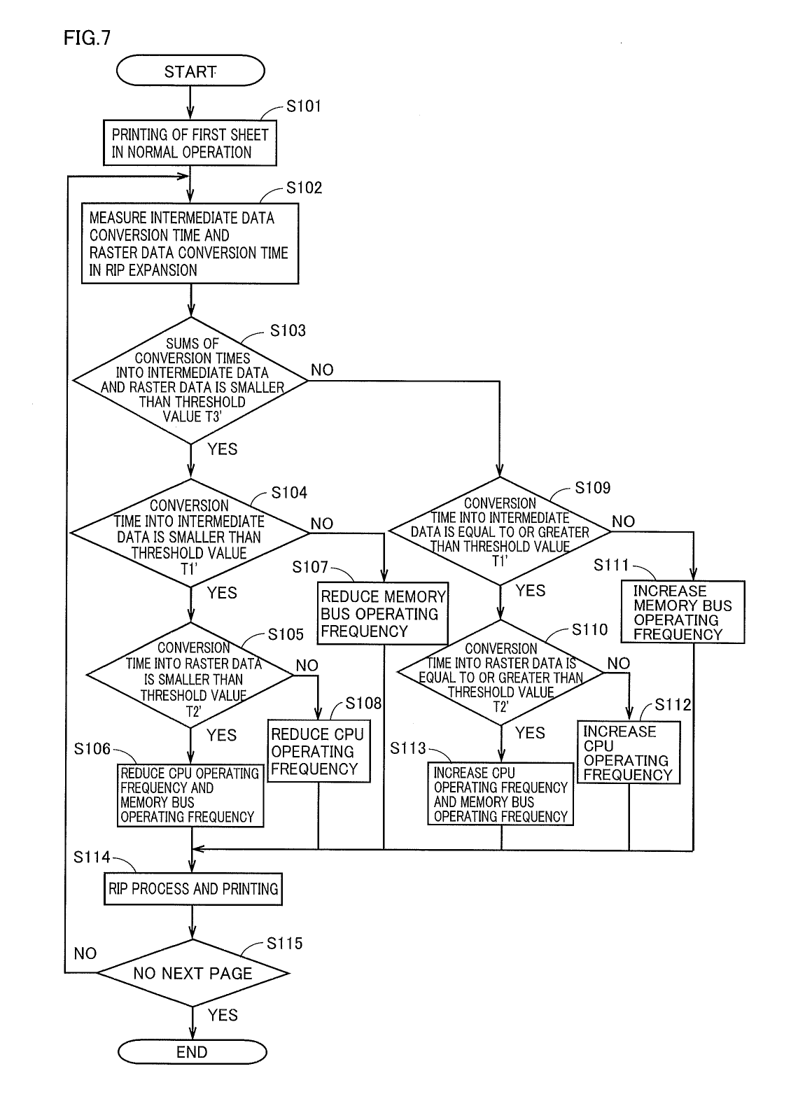

FIG. 7 is a flowchart of the printing process including power saving control executed by CPU 201 of controller unit 150.

This flowchart shows the process from input of PDL print data from an external PC by the image forming apparatus, through the RIP process executed by CPU 201 of controller unit 150, up to output from printer unit 405.

Upon receiving print data from an external PC through network interface 213, CPU 201 starts the RIP process of the first page (first sheet) of the print data in step S101. When the RIP process is finished, printer unit 405 performs printing of the first page (first sheet) based on the processed data. The RIP process of the first page (first sheet) in step S101 is performed under the usual operation environment without lowering the performance (operating frequency, power supply voltage) of CPU 201 and without lowering the operating frequency of the bus. The reason is as follows.

When print data is received and a print job is started, first, the RIP process of the first page is performed, and printing of the first page is thereafter executed in printer unit 405. Therefore, as the RIP process for the first page is faster, the time until print execution is shortened. Thus, in step S101, a power saving process is not performed for the RIP process of the first page.

When the RIP process of the first page is finished, in step S102, CPU 201 measures the time (T1) taken to convert print data into intermediate data and the time (T2) taken to convert intermediate data into raster data in the RIP process of the first page.

In step S103, CPU 201 determines whether the total time (T3) of the conversion time into intermediate data (T1) and the conversion time into raster data (T2) is smaller than a threshold value (T3′). Here, the threshold value (T3′) may be a time taken for printer unit 405 to print one sheet or may a time shorter than the time taken for printer unit 405 to print one sheet. In the present embodiment, the threshold value (T3′) is recorded in a table as described later.

If the total time (T3) is smaller than the threshold value (T3′) in step S103, the speed of the RIP process is too fast, which means that the speed of the RIP process can be reduced. It is also necessary to determine whether the speed of conversion of print data into intermediate data in the RIP process is too fast, or the speed of conversion of intermediate data into raster data is too fast.

Then, if YES in step S103, it is determined whether the conversion time into intermediate data (T1) is smaller than a threshold value (T1′ (where T1′<T3′)) in step S104. Here, the threshold value (T1′) is recorded in a table as described later.

If the conversion time into intermediate data (T1) is smaller than the threshold value (T1′) in step S104, the speed of the process of conversion of print data into intermediate data by CPU 201 is too fast, which means that the processing speed of CPU 201 can be reduced.

If YES in step S104, it is determined whether the conversion time into raster data (T2) is smaller than a threshold time (T2′ (where T2′<T3′)) in step S105. Here, the threshold value (T2′) is recorded in a table as described later.

If the conversion time into raster data (T2) is smaller than the threshold value (T2′) in step S105, the processing speed of CPU 201 as well as the operating frequency of the memory bus is too fast, which means that the processing speed of CPU 201 as well as the operating frequency of the memory bus can be reduced.

Based on this, if YES both in steps S104 and S105, the operating frequency of CPU 201 and the operating frequency of the memory bus are reduced in step S106. The power supply voltage of CPU 201 is also reduced at the same time.

If NO in step S104, although the speed of the RIP process is too fast, the speed of the process of conversion into intermediate data by CPU 201 is not too fast. The speed of the RIP process is too fast because the operating frequency of the memory bus is too fast. Then, in step S107, the operating frequency of the memory bus is reduced.

If NO in step S105, the speed of the RIP process is too fast, that is, the speed of the process of conversion into intermediate data by CPU 201 is too fast. However, the operating frequency of the memory is not too fast. Then, in step S108, the operating frequency of CPU 201 is reduced. The power supply voltage of CPU 201 is also reduced at the same time.

In this manner, the operating frequency of CPU 201, the operating frequency of the memory bus, and the power supply voltage of CPU 201 in the RIP process of print data of the second page are adjusted based on the time required for the RIP process of print data of the first page (the speed of the RIP process).

The RIP process of print data of the second page is performed and printing in printer unit 405 is performed in step S114 in the state in which the operating frequency of the memory bus and the operating frequency and power supply voltage of CPU 201 are adjusted.

In step S115, if processing of print data of the next page (here, the third page) is necessary (NO in step S115), the process returns to step S102. Here, in step S102-S108, the operating frequency of CPU 201, the operating frequency of the memory bus, and the power supply voltage of CPU 201 in the RIP process of print data of the third page are adjusted based on the speed of the RIP process of print data of the first page and the speed of the RIP process of print data of the second page. More specifically, in the present embodiment, the operating frequency of CPU 201, the operating frequency of the memory bus, and the power supply voltage of CPU 201 in the RIP process of print data of the third page are adjusted, depending on whether the following (1)-(3) are equal to or greater than, or smaller than, the predetermined threshold values T1′, T2′, and T3′, respectively, for determination of the RIP process speed of the second page:

(1) the sum of the time required for the RIP process of print data of the first page and the time required for the RIP process of print data of the second page;

(2) the sum of the time required for conversion of print data of the first page into intermediate data and the time required for conversion of print data of the second page into intermediate data; and

(3) the sum of the time required for conversion of intermediate data of print data of the first page into raster data and the time required for conversion of the intermediate data of print data of the second page into raster data.

In the present embodiment, in the processing of print data of the n-th page, the operating frequency of CPU 201, the operating frequency of the memory bus, and the power supply voltage of CPU 201 in the RIP process of print data of the n-th page are adjusted, depending on whether the following (1)-(3) are equal to or greater than, or smaller than, the predetermined threshold values T1′, T2′, and T3′, respectively, for determination of the RIP process speed of the (n−1)th page:

(1) the total of the times required for the RIP process of print data of the first to (n−1)th pages;

(2) the total of the times required for conversion of print data of the first to (n−1)th pages into intermediate data; and

(3) the total of the times required for conversion of intermediate data of print data of the first to (n−1)th pages into raster data.

In other words, the cumulative value from the first page is measured as the total time (T3) of the conversion time into intermediate data (T1) and the conversion time from intermediate data into raster data (T2). The cumulative value is compared with the threshold value (T3′) for evaluating the cumulative value. The threshold value (T3′) is set so as to increase every processing of one page.

The cumulative value of the conversion times from the first page is measured as the conversion time into intermediate data (T1). The cumulative value is compared with the threshold value (T1′) for evaluating the cumulative value. The threshold value (T1′) is set so as to increase every processing of one page.

The cumulative value of the conversion times from the first page is measured as the conversion time from intermediate data into raster data (T2). The cumulative value is compared with the threshold value (T2′) for evaluating the cumulative value. The threshold value (T2′) is set so as to increase every processing of one page.

It is noted that the apparatus may be configured such that the operating frequency of CPU 201, the operating frequency of the memory bus, and the power supply voltage of CPU 201 in the RIP process of print data of the third page may be adjusted only based on the speed of the RIP process of print data of the second page (without considering the speed of the RIP process of print data of the first page).

More specifically, in the processing of print data of the n-th page, the operating frequency of CPU 201, the operating frequency of the memory bus, and the power supply voltage of CPU 201 in the RIP process of print data of the n-th page are adjusted, depending on whether the following (1)-(3) are equal to or greater than, or smaller than, the predetermined respective threshold values for determination of the RIP process speed:

(1) the time required for the RIP process of print data of the (n−1)th page;

(2) the time required for conversion of print data of the (n−1)th page into intermediate data; and

(3) the time required for conversion of intermediate data of print data of the (n−1)th page into raster data.

If the total time (T3) is equal to or greater than the threshold value (T3′) in step S103 in FIG. 7 (NO in step S103), the RIP process is too slow, which means that it is necessary to increase the processing speed.

Then, if NO in step S103, it is determined whether the conversion time into intermediate data (T1) is equal to or greater than the threshold value (T1′ (where T1′<T3′)) in step S109.

If the conversion time into intermediate data (T1) is equal to or greater than the threshold value (T1′) in step S109, the conversion process into intermediate data by CPU 201 is too slow, which means that it is necessary to increase the processing speed of CPU 201.

If YES in step S109, it is determined whether the conversion time from intermediate data into raster data (I′2) is equal to or greater than the threshold value (T2′ (where T2′<T3′)) in step S110.

If the conversion time into raster data (T2) is equal to or greater than the threshold value (T2′) in step S110, the operating frequency of the bus is too slow, which means it is necessary to increase the operating frequency of the bus.

Based on this, if YES both in steps S109 and S110, the operating frequency of CPU 201 and the operating frequency of the memory bus are increased in step S113. The power supply voltage of CPU 201 is also increased at the same time.

If NO in step S109, the RIP process speed is too slow but the operating frequency of the CPU is not too slow. That is, the RIP process is slow because the operating frequency of the memory bus is too low. Therefore, in step S111, the operating frequency of the memory bus is increased.

If NO in step S110, the RIP process speed is too slow and the operating frequency of the CPU is too slow. However, the operating frequency of the memory bus is not too slow. That is, the RIP process speed is slow because the operating frequency of the CPU is too low. Therefore, in step S112, the operating frequency of CPU 201 is increased. The power supply voltage of CPU 201 is also increased at the same time.

The RIP process of print data and printing in printer unit 405 are performed in step S114 in the state in which the operating frequency of the memory bus and the operating frequency of CPU 201 are adjusted.

It is noted that the upper and lower limit values of the operating frequency of CPU 201, the operating frequency of the memory bus, and the power supply voltage of CPU 201 are set, and control is performed such that those values are not exceeded.

When the operating frequency of CPU 201, the operating frequency of the memory bus, and the power supply voltage of CPU 201 are changed, the amount of change at a time is fixed (at a prescribed amount). If a change at a prescribed amount does not suffice, an additional change at the prescribed amount is carried out in the processing of the next page. For example, when it is determined that the operating speed of the CPU in the RIP process of the first page is too fast, the operating frequency of the CPU is reduced by the prescribed amount in the RIP process of the second page. When it is determined that the operating speed of the CPU in the RIP process of the second page is too fast, the operating frequency of the CPU is further reduced by the prescribed amount in the RIP process of the third page. In this manner, the setting is made such that the operating frequency of the CPU is reduced step by step. Through a similar process, the power supply voltage of the CPU can be reduced step by step, and the operating frequency of the memory bus can be reduced step by step. This is applicable to the case where the operating frequency of CPU 201, the operating frequency of the memory bus, and the power supply voltage of CPU 201 are increased.

On the other hand, when the operating frequency of CPU 201, the operating frequency of the memory bus, and the power supply voltage of CPU 201 are changed, they may be changed by the amount corresponding to the difference between the measured time (T1, T2, T3) and the threshold value (T1′, T2′, T3′). In other words, as the difference between the measured time (T1, T2, T3) and the threshold value (T1′, T2′, T3′) is greater, the amount of changing the operating frequency of CPU 201, the operating frequency of the memory bus, and the power supply voltage of CPU 201 is set greater.

In FIG. 7, power can be saved by reducing at least one of the CPU operating frequency, the CPU power supply voltage, and the memory bus operating frequency, through the process in steps S106-S108.

A description will now be made to the table in which the threshold values T1′, T2′, T3′ are recorded, and to the process of controlling the operating frequency and the power supply voltage in the present embodiment by determining the RIP process speed using the table in accordance with the flowchart in FIG. 7.

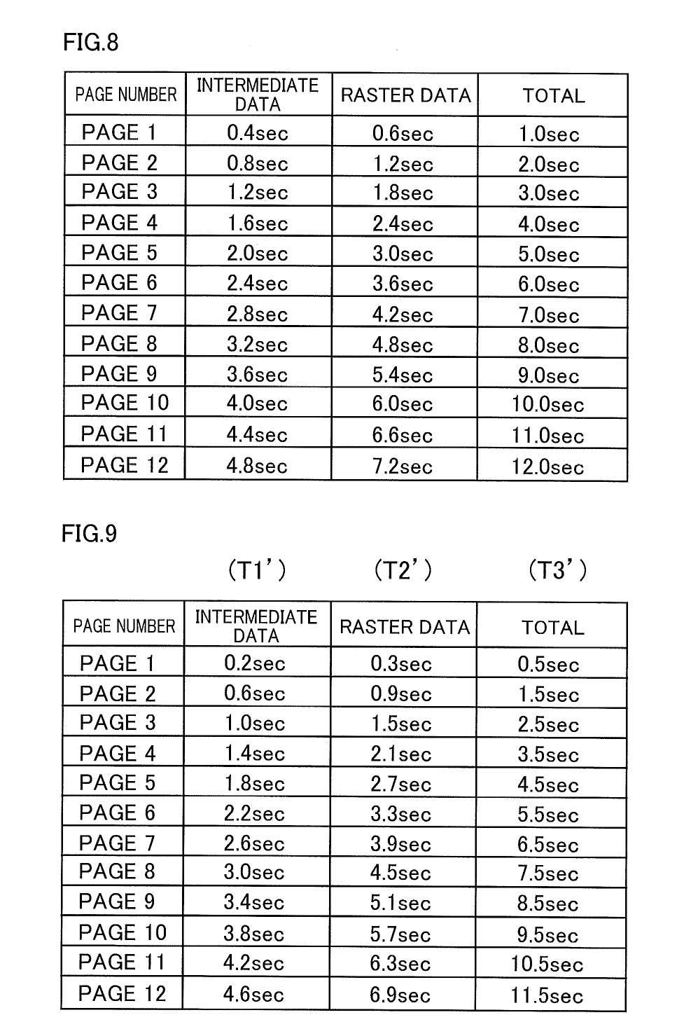

FIG. 8 specifically shows the longest possible time available for the RIP process in the image forming apparatus capable of printing 60 sheets in 60 seconds.

In the figure, for the processing of print data of 12 pages, the maximum values of the conversion time into intermediate data, the conversion time into raster data, and the total time (the time required for the RIP process) are shown as the cumulative values from the start of printing of the first page.

In order to perform the printing process of 60 sheets in 60 seconds, the RIP process time for one page has to be equal to or shorter than 1.0 second. If the RIP process for one page is 1.0 second, the conversion time into intermediate data is 0.4 seconds and the conversion time into raster data is 0.6 seconds, in that RIP process.

FIG. 9 shows a specific example of a comparison table for performing frequency change control.

The figure shows the threshold value (comparative value) (T1′) of the conversion time into intermediate data, the threshold time (T2′) of the conversion time from intermediate data into raster data, and the threshold value (T3′) of the total time (the time required for the RIP process), in the case where the processing of print data for each of 12 pages is performed.

Such a comparison table is obtained beforehand using a formula in accordance with the printer processing speed and is recorded in the apparatus. A method of generating the comparison table will be described below. The comparison table may be generated every time a job is received. However, in order to prevent a reduction of the job processing speed, it is desirable that a table generated beforehand is stored in the apparatus. Every time the RIP process of one page is executed, the threshold values (T1′-T3′) for evaluating the speed of that RIP process may be calculated.

First, the threshold value (T1′) of the conversion time into intermediate data, the threshold value (T2′) of the conversion time into raster data, and the threshold value (T3′) of the total time (the time required for the RIP process) for the first page in the comparison table are calculated. In FIG. 9, T1′ is 0.2 seconds, T2′ is 0.3 seconds, and T3′ is 0.5 seconds, in the first page. These values are set such that values of T1′, T2′, T3′ of the first page in FIG. 9 are ½ of the conversion time into intermediate data (0.4 seconds), the conversion time into raster data (0.6 seconds), and the RIP process time (1.0 second), respectively, which are the longest possible time available for the processing of one page as shown in FIG. 8.

Next, the threshold values T1′, T2′, T3′ of the second page in FIG. 9 are calculated. These values are obtained by adding the conversion time into intermediate data (0.4 seconds), the conversion time into raster data (0.6 seconds), and the RIP process time (1.0 second), which are the longest possible time available for the processing of one page as shown in FIG. 8, to the threshold value (T1′=0.2 seconds) of the conversion time into intermediate data, the threshold value (T2′=0.3 seconds) of the conversion time into raster data, and the threshold value (T3′=0.5 seconds) of the total time (the time required for the RIP process), respectively, for the first page in FIG. 9.

Therefore, in FIG. 9, for the second page, the threshold value T1′ is 0.2+0.4=0.6 seconds, the threshold value T2′ is 0.3+0.6=0.9 seconds, and the threshold value T3′ is 0.5+1.0=1.5 seconds.

Similarly, the threshold values T1′, T2′, T3′ of the third page are obtained by adding the conversion time into intermediate data (0.4 seconds), the conversion time into raster data (0.6 seconds), and the RIP process time (1.0 second), which are the longest possible time for the processing of one page as shown in FIG. 8, to the threshold value (T1′=0.6 seconds) of the conversion time into intermediate data, the threshold value (T2′=0.9 seconds) of the conversion time into raster data, and the threshold value (T3′=1.5 seconds) of the total time (the time required for the RIP process), respectively, for the second page in FIG. 9.

Therefore, in FIG. 9, for the third page, the threshold value T1′ is 0.6+0.4=1.0 second, the threshold value T2′ is 0.9+0.6=1.5 seconds, and the threshold value T3′ is 1.5+1.0=2.5 seconds.

In this manner, the table shown in FIG. 9 can be obtained by successively adding the longest possible time available for one page to the threshold value in the previous page. In other words, the threshold value (T1′) of the conversion time into intermediate data, the threshold value (T2′) of the conversion time into raster data, and the threshold value (T3′) of the total time (the time required for the RIP process) in a page after the second page in FIG. 9 are obtained by the equation below:

the threshold value of the first page+the longest possible time available for the processing of one page×(the page number−1) (1).

For example, the threshold value (T1′) of the conversion time into intermediate data of the third page in FIG. 9 is calculated as 0.2 seconds+0.4 seconds×(3−1)=1.0 second, based on the equation (1) above, where the threshold value of the first page=0.2 seconds, the time required for the processing of one page=0.4 seconds, and the page number=3.

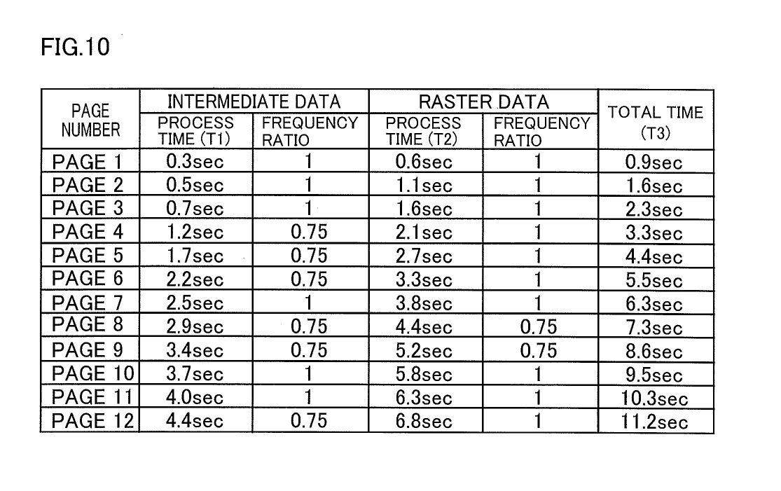

FIG. 10 shows an example in which operating frequencies are switched based on the table in FIG. 9.

Here shown is an example in which print data of 12 pages is processed based on the table in FIG. 9. The processing times T1, T2, T3 in FIG. 10 are the actually measured values.

Printing of the first page is done at a normal processing speed (frequency ratio=1) (step S101 in FIG. 7). Here, the conversion time into intermediate data (T1) is measured as 0.3 seconds, the conversion time into raster data (T2) is measured as 0.6 seconds, and the time (T3) required for the RIP process is measured as 0.9 seconds (step S102 in FIG. 7). In printing of the second page, the operating frequency of CPU 201, the operating frequency of the memory bus, and the power supply voltage of CPU 201 are controlled based on these actually measured times.

Specifically, it is determined whether the time required for the RIP process (T3=0.9 seconds), that is, the total time of the conversion time into intermediate data (T1) and the conversion time into raster data (T2) that are actually measured in the processing of the first page, is smaller than the threshold value (T3′=0.5 seconds) of the first page in the table in FIG. 9 (step S103 in FIG. 7). Here, the actually measured time required for the RIP process (0.9 seconds) is greater than the corresponding threshold value (0.5 seconds) of the first page in FIG. 9. Therefore, the determination is NO in step S103 in FIG. 7.

Thereafter, in step S109 in FIG. 7, the determination is YES since the conversion time into intermediate data that is actually measured in the processing of the first page (T1=0.3 seconds) is greater than the corresponding threshold value of the first page in FIG. 9 (T1′=0.2 seconds).

In step S110 in FIG. 7, the determination is YES since the conversion time into raster data that is actually measured in the processing of the first page (0.6 seconds) is greater than the corresponding threshold value of the first page in FIG. 9 (0.3 seconds).

Thereafter, in step S113, control should be performed to increase the operating frequency of CPU 201, the operating frequency of the memory bus, and the power supply voltage of CPU 201. However, here, they are at the upper limit values (the state in which a power saving process is not performed, that is, the usual state (frequency ratio=1)). Therefore, the operating frequency of CPU 201, the operating frequency of the memory bus, and the power supply voltage of CPU 201 are not increased.

Thereafter, in step S114 in FIG. 7, the RIP process and printing for print data of the second page are performed. In the determination in step S115, the process returns to step S102 for processing of the next page (the third page).

When printing of the third page is done, the operating frequency of CPU 201, the operating frequency of the memory bus, and the power supply voltage of CPU 201 are controlled based on the actually measured time for the RIP process of the first page and the second page.

Specifically, as shown in “the second page” in FIG. 10, the measurement result shows that the conversion time into intermediate data (T1), which is the total time of the first page and the second page, is measured as 0.5 seconds, the conversion time into raster data (T2) is measured as 1.1 seconds, and the time (T3) required for the RIP process is measured as 1.6 seconds (step S102 in FIG. 7). In printing of the third page, the operating frequency of CPU 201, the operating frequency of the memory bus, and the power supply voltage of CPU 201 are controlled based on these actually measured times.

The time required for the RIP process (T3=1.6 seconds), which is the total time of the conversion time into intermediate data (T1) and the conversion time into raster data (T2) that are actually measured in the processing of the second page, is greater than the threshold value (1.5 seconds) of the second page in the table in FIG. 9 (NO in step S103 in FIG. 7). Therefore, the operating frequency of CPU 201, the operating frequency of the memory bus, and the power supply voltage of CPU 201 are not increased in the processing of the third page, as in the second page (this is because all of them are at the upper limit values).

Thereafter, in step S114 in FIG. 7, the RIP process and printing for print data of the third page are performed. In the determination in step S115, the process returns to step S102 for processing of the next page (the fourth page).

In printing of the fourth page, the operating frequency of CPU 201, the operating frequency of the memory bus, and the power supply voltage of CPU 201 are controlled based on the actually measured time of the RIP process of the first to third pages.

Specifically, it is determined whether the time required for the RIP process (2.3 seconds), which is the total time of the conversion time into intermediate data and the conversion time into raster data that are actually measured in the processing of the first page to the third page, is smaller than the threshold value (2.5 seconds) of the third page in the table in FIG. 9 (step S103 in FIG. 7). Here, the actually measured time required for the RIP process (2.3 seconds) is smaller than the corresponding threshold value (2.5 seconds) of the third page in FIG. 9. Therefore, the determination in step S103 in FIG. 7 is YES.

Thereafter, in step S104 in FIG. 7, the determination is YES since the conversion time into intermediate data (0.7 seconds) that is actually measured in the processing of the first page to the third page is smaller than the corresponding threshold value (1.0 second) of the third page in FIG. 9.

Thereafter, in step S105 in FIG. 7, the determination is NO since the conversion time into raster data (1.6 seconds) that is actually measured in the processing of the first page to the third page is greater than the corresponding threshold value (1.5 seconds) of the third page in FIG. 9.

Accordingly, in the processing of the fourth page, the operating frequency and the power supply voltage of CPU 201 are reduced in step S108, and the RIP process and printing of print data of the fourth page are performed with reduced power in step S114 in FIG. 7. In this example, in order to reduce the operating frequency, the operating frequency is set to be 0.75 times the usual one.

Thereafter, in the determination in step S115, the process returns to step S102 for processing of the next page (the fifth page).

In the processing of the fifth page and the sixth page, control is performed as follows, based on the measured time up to the fourth page and the measured time up to the fifth page, respectively.

The time required for the RIP process (3.3 seconds) that is actually measured in the processing of the first to fourth pages is smaller than the threshold value (3.5 seconds) of the fourth page in the table in FIG. 9 (YES in step S103 in FIG. 7). Furthermore, the measured time (1.2 seconds) of the conversion time into intermediate data of the first to fourth pages is smaller than the threshold value (1.4 seconds) of the fourth page in the table in FIG. 9 (YES in step S104 in FIG. 7). Furthermore, the measured value (2.1 seconds) of the conversion time into raster data of the first to fourth pages is equal to or greater than the threshold value (2.1 seconds) of the fourth page in the table in FIG. 9 (NO in step S105 in FIG. 7). Accordingly, control should be performed to reduce the operating frequency of CPU 201 and the power supply voltage of CPU 201 in the RIP process of the fifth page (step S108). However, here, they are at the lower limit values (the operating frequency=0.75 times). Therefore, the operating frequency of CPU 201, the operating frequency of the memory bus, and the power supply voltage of CPU 201 are not reduced. This is applicable to the RIP process of the sixth page.

Printing of the seventh page is now described.

The time required for the RIP process (5.5 seconds) that is actually measured in the processing of the first to sixth pages is equal to or greater than the threshold value (5.5 seconds) of the sixth page in the table in FIG. 9 (NO in step S103 in FIG. 7). Furthermore, the measured value (2.2 seconds) of the conversion time into intermediate data of the first to sixth pages is equal to or greater than the threshold value (2.2 seconds) of the sixth page in the table in FIG. 9 (YES in step S109 in FIG. 7). On the other hand, the measured value (3.3 seconds) of the conversion time into raster data of the first to sixth pages is equal to or greater than the threshold value (3.3 seconds) of the sixth page in the table in FIG. 9 (YES in step S110 in FIG. 7).

Accordingly, control is performed to increase the operating frequency of CPU 201 and the power supply voltage of CPU 201 (step S113 in FIG. 7). Here, the CPU operating frequency of 0.75 times is returned to 1. The operating frequency of the memory bus, which is already at the upper limit value (1.0 time), is not increased.

Printing of the eighth page is now described.

The time required for the RIP process (6.3 seconds) that is actually measured in the processing of the first to seventh pages is smaller than the threshold value (6.5 seconds) of the seventh page in the table in FIG. 9 (YES in step S103 in FIG. 7). Furthermore, the measured value (2.5 seconds) of the conversion time into intermediate data of the first to seventh pages is smaller than the threshold value (2.6 seconds) of the seventh page in the table in FIG. 9 (YES in step S104 in FIG. 7). Furthermore, the measured value (3.8 seconds) of the conversion time into raster data of the first to seventh pages is smaller than the threshold value (3.9 seconds) of the seventh page in the table in FIG. 9 (YES in step S105 in FIG. 7). Accordingly, control is performed to reduce the operating frequency of CPU 201 and the power supply voltage of CPU 201, and the operating frequency of the memory bus (step S106). Thus, the operating frequency of the memory bus and the operating frequency of CPU 201 are both 0.75 times those in the RIP process of the eighth page.

A description of printing in the ninth and subsequent pages is not repeated since it is similar to the forgoing description.

In this manner, based on the measured value (cumulative value) of the time required for the RIP process up to a certain page, the performance of the RIP process in the following page is determined. In other words, if the measured total time (cumulative value) of the RIP process up to the previous page is smaller than the threshold value set for each page in step S103 in the flowchart in FIG. 7 (YES in step S103), one or both of the memory bus operating frequency and the CPU operating frequency are reduced thereby reducing power consumption. Such a reduction process is carried out for each processing of one page.

This process is repeated every page, so that the memory bus operating frequency and the CPU operating frequency are repeatedly reduced or increased (returned to the original one). The performance is always adjusted with the frequencies being varied, so that a printing process can be performed within a required time period with reduced power consumption.

### Second Embodiment

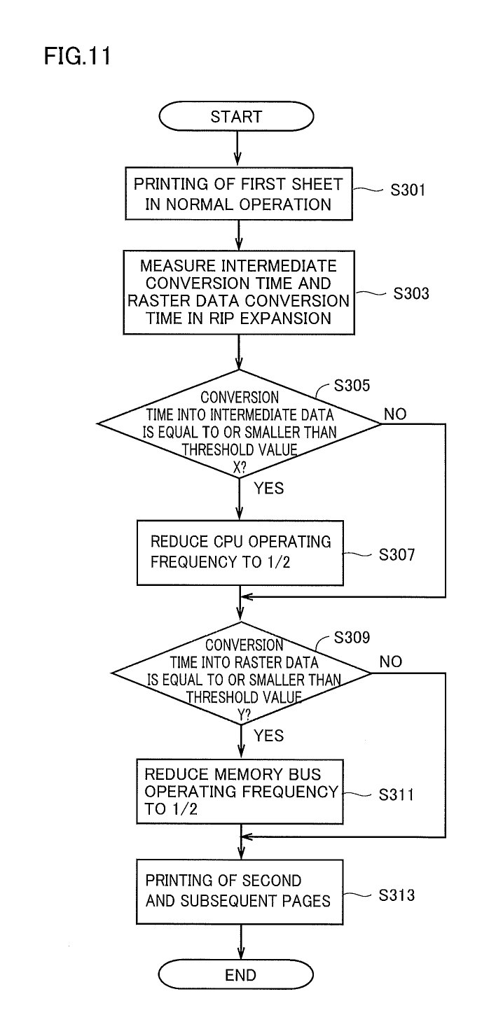

FIG. 11 is a flowchart of the printing process including power saving control executed by the image forming apparatus in a second embodiment of the present invention.

The hardware configuration of the image forming apparatus in the second embodiment is the same as that of the first embodiment, and therefore a description thereof will not be repeated here.

The process in FIG. 11 is executed by CPU 201 of controller unit 150. This flowchart shows the process from input of PDL print data by the image forming apparatus from an external PC, through the RIP process by CPU 201 of controller unit 150, up to output by printer unit 405.

Referring to FIG. 11, upon receiving print data from an external PC through network interface 213, CPU 201 starts the RIP process of the first page (first sheet) of the print data in step S301. When the RIP process is finished, printer unit 405 performs printing of the first page (first sheet) based on the processed data. The RIP process of the first page (first sheet) in step S301 is performed under the usual operation environment without lowering the performance (operating frequency, power supply voltage) of CPU 201 and without lowering the operating frequency of the bus. The RIP process of the first page is performed fast in order to shorten the time until print execution.

When the RIP process of the first page is finished, in step S303, CPU 201 measures the time (T1) taken to convert print data into intermediate data and the time (T2) taken to convert intermediate data into raster data in the RIP process of the first page.

In step S305, CPU 201 determines whether the time (T1) taken to convert print data into intermediate data as measured in step S303 is equal to or smaller than a threshold value (X) for evaluating the time taken to convert print data into intermediate data. Here, the threshold value (X) is ¼ of the time required for printer unit 405 to print one sheet. If YES in step S305, the operating frequency of the CPU is reduced to ½, and the CPU power supply voltage is reduced to ¾, in step S307.

In step S309, CPU 201 determines whether the time (T2) taken to convert intermediate data into raster data as measured in step S303 is equal to or smaller than a threshold value (Y) for evaluating the time taken to convert intermediate data into raster data. Here, the threshold value (Y) is ¼ of the time required for printer unit 405 to print one sheet. If YES in step S309, the operating frequency of the memory bus is reduced to ½ in step S311.

The RIP process of print data of the second page is performed and printing in printer unit 405 is performed in step S313 in the state in which the operating frequency of the memory bus and the operating frequency and the power supply voltage of CPU 201 are adjusted. The processing of the third and subsequent pages is performed similarly to the second page.

As described above, in the present embodiment, the lower limit value of the operating frequency of the memory bus is ½ of the standard state, and the lower limit value of the operating frequency of CPU is ½ of the standard state.

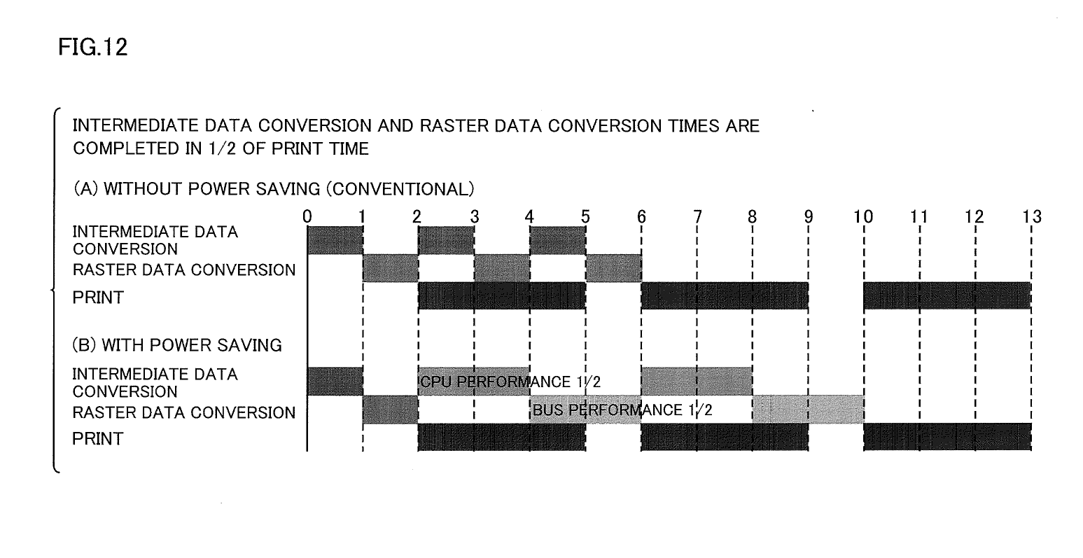

FIG. 12 is a timing chart schematically showing a first process executed by the image forming apparatus in the second embodiment of the present invention.

FIG. 12 shows the time in which the RIP process is performed and the time in which printing is performed, in a case where a three-page image is printed. As the time in which the RIP process is performed, there are shown the conversion time of print data into intermediate data and the conversion time of intermediate data into raster data. The horizontal axis shows the elapsed time since the start of the process and shows the process which is performed in 13 units of time from time “0” to time “13.”

FIG. 12(A) shows the conventional process without power saving, and FIG. 12(B) shows the process in the present embodiment with power saving.

As shown in FIG. 12(A), in the conventional process without power saving, conversion of print data into intermediate data for the first page is performed from time “0” to time “1.” Conversion of intermediate data into raster data for the first page is performed from time “1” to time “2.” Conversion of print data into intermediate data for the second page is performed from time “2” to time “3.” Conversion of intermediate data into raster data for the second page is performed from time “3” to time “4.” Conversion of print data into intermediate data for the third page is performed from time “4” to time “5.” Conversion of intermediate data into raster data for the third page is performed from time “5” to time “6.”

Printing of raster data of the first page is started at time “2” and finished at time “5.” Thereafter, a print interval time is provided from time “5” to time “6.” Printing of raster data of the second page is started at time “6” and finished at time “9.” Thereafter, a print interval time is provided from time “9” to time “10.” Printing of raster data of the third page is started at time “10” and finished at time “13.”

In this manner, it is assumed that the conversion time of print data into intermediate data for one page is one unit of time, and that the conversion time of intermediate data into raster data is also one unit of time. Immediately when the conversion into raster data for the first page is completed, conversion of print data into intermediate data for the second page is started. Simultaneously with the start of conversion of print data into intermediate data for the second page, printing of print data of the first page is started. Printing of an image of one page requires a total of four units of time including three units of time in the hatched portion in the figure and one unit time of interval time.

In other words, the RIP time (the total time of the conversion time into intermediate data and the conversion time from intermediate data into raster data) is ½ of the print time. The conversion time of print data into intermediate data is ¼ of the print time. The conversion time of intermediate data into raster data is ¼ of the print time.

A description will now be given as to the case where the same data as in the conventional process without power saving in FIG. 12(A) is processed by the image forming apparatus in the present embodiment.

In the process with power saving in the present embodiment, the RIP process for the first sheet in step S301 in FIG. 11 is performed in the usual operation. Specifically, conversion of print data into intermediate data for the first page is performed from time “0” to time “1.” Conversion of intermediate data into raster data for the first page is performed from time “1” to time “2.” Printing of raster data of the first page is started at time “2” and finished at time “5.” Thereafter, a print interval time is provided from time “5” to time “6.”

When the RIP process for the first page is completed, in step S303, CPU 201 measures the time (T1) taken to convert print data into intermediate data and the time (T2) taken to convert intermediate data into raster data in the RIP process for the first page.

Then, in step S305, it is determined whether the time (T1) taken to convert print data into intermediate data as measured in step S303 is equal to or smaller than the threshold value (X) for evaluating the time taken to convert print data into intermediate data. Here, the threshold value (X) is ¼ of the time required for printer unit 405 to print one sheet (four units of time including the interval time). Therefore, in step S305, the determination is YES. Then, in step S307, the operating frequency of the CPU is reduced to ½, and the CPU power supply voltage is reduced to ¾.

In step S309, CPU 201 determines whether the time (T2) taken to convert intermediate data into raster data as measured in step S303 is equal to or smaller than the threshold value (Y) for evaluating the time taken to convert intermediate data into raster data. Here, the threshold time (Y) is ¼ of the time required for printer unit 405 to print one sheet (four units of time including the interval time). Therefore, in step S309, the determination is YES. Then, in step S311, the operating frequency of the memory bus is reduced to ½.

The RIP process of print data of the second page and printing in printer unit 405 are performed in step S313 in the state in which the operating frequency of the memory bus and the operating frequency and the power supply voltage of CPU 201 are adjusted. The processing of the third page is performed similarly to the second page.

In this manner, as shown in FIG. 12(B), in the present embodiment, a process of reducing the speed of conversion into intermediate data and the speed of conversion into raster data for the second and third pages to ½ is performed. Specifically, the CPU operating frequency is changed to ½, the CPU power supply voltage is changed to ¾, and the memory bus operating frequency is changed to ½. The RIP process for the first page is performed at the normal speed (the same speed as in FIG. 12(A)), so that a delay in the printing start time of the first page is prevented (step S301 in FIG. 11).

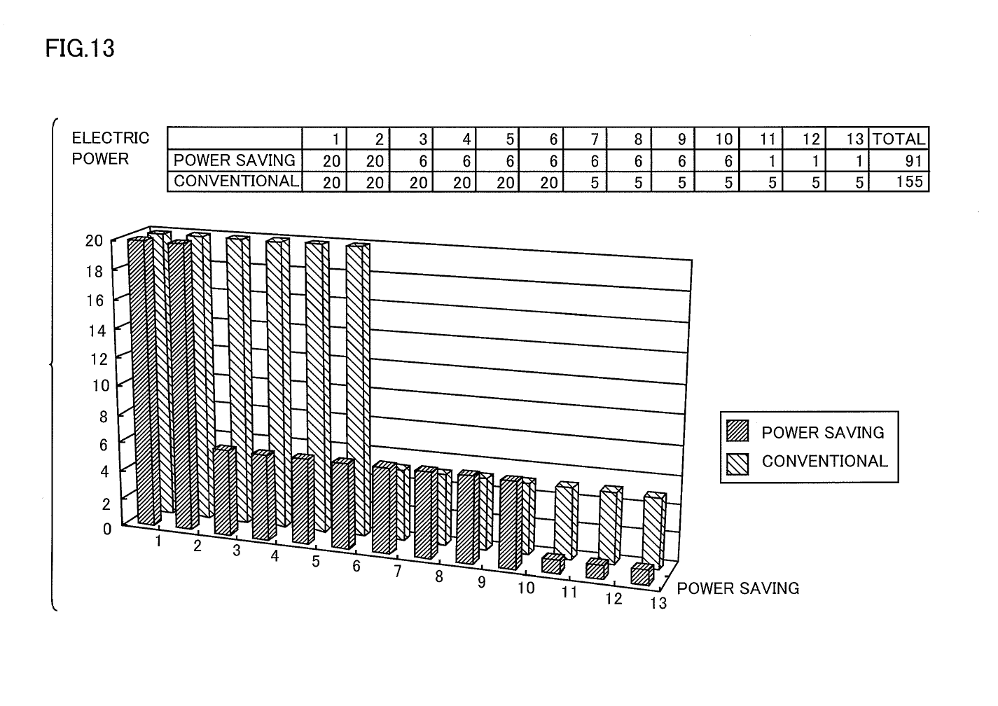

FIG. 13 shows a specific example of a power saving effect achieved by controller unit 150 when the process in FIG. 12 is performed.

“Power saving” in the figure shows power consumption in the RIP process in the case where the process in FIG. 12(B) is performed. “Conventional” in the figure shows power consumption in the RIP process in the case where the process in FIG. 12(A) is performed.

Referring to the figure, in the “conventional” process, it is assumed that the power consumption in controller unit 150 is “20” per unit time in the period until the time “6” during which the RIP process is performed, and that the power consumption in controller unit 150 is “5” in the following period until time “13” during which only printing is done. Here, the power consumption only in controller unit 150 is shown and the power consumption in printer unit 405 is not included. Therefore, the value of power consumption (“20”) until time “2” at which printing is started is equal to the value of power consumption (“20”) from time “2” at which printing is started to time “6.”

Although the RIP process is finished at time “6,” the CPU and the memory bus in controller unit 150 continue to operate at a similar speed as before time “6.” Therefore, the power consumption in controller unit 150 does not become “0.” Here, the power consumption in controller unit 150 after time “6” is “5.”

When the “power saving” process is performed, controller unit 150 consumes power of “20” in each unit of time until time “2” during which time the RIP process for the first page is performed, similarly to the “conventional” process, as shown in the processing in step S301 in FIG. 11. In the subsequent processing until time “10,” the CPU operating frequency is changed to ½, the CPU power supply voltage is changed to ¾, and the memory bus operating frequency is changed to ½ in controller unit 150. As a result, the power consumption per unit time is “6” from time “2” to time “10,” and the total power consumption from time “3” to time “10” can be reduced to “42” as compared with the conventional “80.” The clock frequencies of the CPU and the memory bus in controller unit 150 remain low from time “10” at which the RIP process is finished to time “13,” so that the power consumption of controller unit 150 can be reduced to “1.”

Accordingly, as can be seen in the “total” field in FIG. 13, the total power consumption, which is “155” in the “conventional” process, can be reduced to “91.”

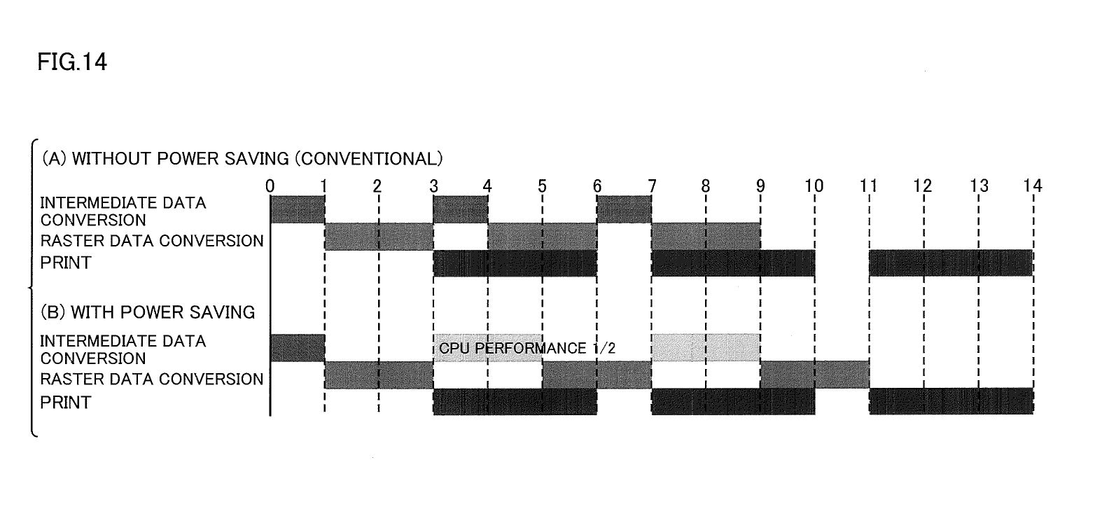

FIG. 14 is a timing chart schematically showing a second process executed by the image forming apparatus in the second embodiment of the present invention.

FIG. 14 shows the time in which the RIP process is performed and the time in which printing is performed, in a case where a three-page image is printed. As the time in which the RIP process is performed, there are shown the conversion time of print data into intermediate data and the conversion time of intermediate data into raster data. The horizontal axis shows the elapsed time since the start of the process and shows the process which is performed in 14 units of time from time “0” to time “14.”

FIG. 14(A) shows the conventional process without power saving, and FIG. 14(B) shows the process in the present embodiment with power saving.

As shown in FIG. 14(A), in the conventional process without power saving, conversion of print data into intermediate data for the first page is performed from time “0” to time “1.” Conversion of intermediate data into raster data for the first page is performed from time “1” to time “3.” Conversion of print data into intermediate data for the second page is performed from time “3” to time “4.” Conversion of intermediate data into raster data for the second page is performed from time “4” to time “6.” Conversion of print data into intermediate data for the third page is performed from time “6” to time “7.” Conversion of intermediate data into raster data for the third page is performed from time “7” to time “9.”

Printing of raster data of the first page is started at time “3” and finished at time “6.” Thereafter, a print interval time is provided from time “6” to time “7.” Printing of raster data of the second page is started at time “7” and finished at time “10.” Thereafter, a print interval time is provided from time “10” to time “11.” Printing of raster data of the third page is started at time “11” and finished at time “14.”

In this manner, it is assumed that the conversion time of print data into intermediate data for one page is one unit of time, and that the conversion time of intermediate data into raster data is two units of time. Immediately when conversion into raster data for the first page is completed, conversion of print data into intermediate data for the second page is started. Simultaneously with the start of conversion of print data into intermediate data for the second page, printing of print data of the first page is started. Printing of an image of one page requires a total of four units of time including three units of time in the hatched portion in the figure and one unit time of interval time.

In other words, the RIP time (the total time of the conversion time into intermediate data and the conversion time from intermediate data into raster data) is ¾ of the print time. The conversion time of print data into intermediate data is ¼ of the print time. The conversion time of intermediate data into raster data is ½ of the print time.

A description will now be given as to the case where the same data as in the conventional process without power saving in FIG. 14(A) is processed by the image forming apparatus in the present embodiment.

In the process with power saving in the present embodiment, the RIP process for the first sheet in step S301 in FIG. 11 is performed in the usual operation. Specifically, conversion of print data into intermediate data for the first page is performed from time “0” to time “1.” Conversion of intermediate data into raster data for the first page is performed from time “1” to time “3.” Printing of raster data of the first page is started at time “3” and finished at time “6.” Thereafter, a print interval time is provided from time “6” to time “7.”

When the RIP process for the first page is completed, in step S303, CPU 201 measures the time (T1) taken to convert print data into intermediate data and the time (T2) taken to convert intermediate data into raster data in the RIP process for the first page.

Then, in step S305, it is determined whether the time (T1) taken to convert print data into intermediate data as measured in step S303 is equal to or smaller than the threshold value (X) for evaluating the time taken to convert print data into intermediate data. Here, the threshold value (X) is ¼ of the time required for printer unit 405 to print one sheet (four units of time including the interval time). Therefore, in step S305, the determination is YES. Then, in step S307, the operating frequency of CPU is reduced to ½, and the CPU power supply voltage is reduced to ¾.

In step S309, CPU 201 determines whether the time (T2) taken to convert intermediate data into raster data as measured in step S303 is equal to or smaller than the threshold value (Y) for evaluating the time taken to convert intermediate data into raster data. Here, the threshold value (Y) is ¼ of the time required for printer unit 405 to print one sheet (four units of time including the interval time). Therefore, in step S309, the determination is NO, and the operating frequency of the memory bus does not change.

The RIP process of print data of the second page and printing in printer unit 405 are performed in step S313 in the state in which the operating frequency and the power supply voltage of CPU 201 are adjusted. The processing of the third page is performed similarly to the second page.

In this manner, as shown in FIG. 14(B), in the present embodiment, a process of reducing the speed of conversion into intermediate data for the second and third pages to ½ is performed. Specifically, in the processing of the second and third pages, the CPU operating frequency is changed to ½, and the CPU power supply voltage is changed to ¾. The RIP process for the first page is performed at the normal speed (the same speed as in FIG. 14(A)), so that a delay in the printing start time of the first page is prevented (step S301 in FIG. 11).

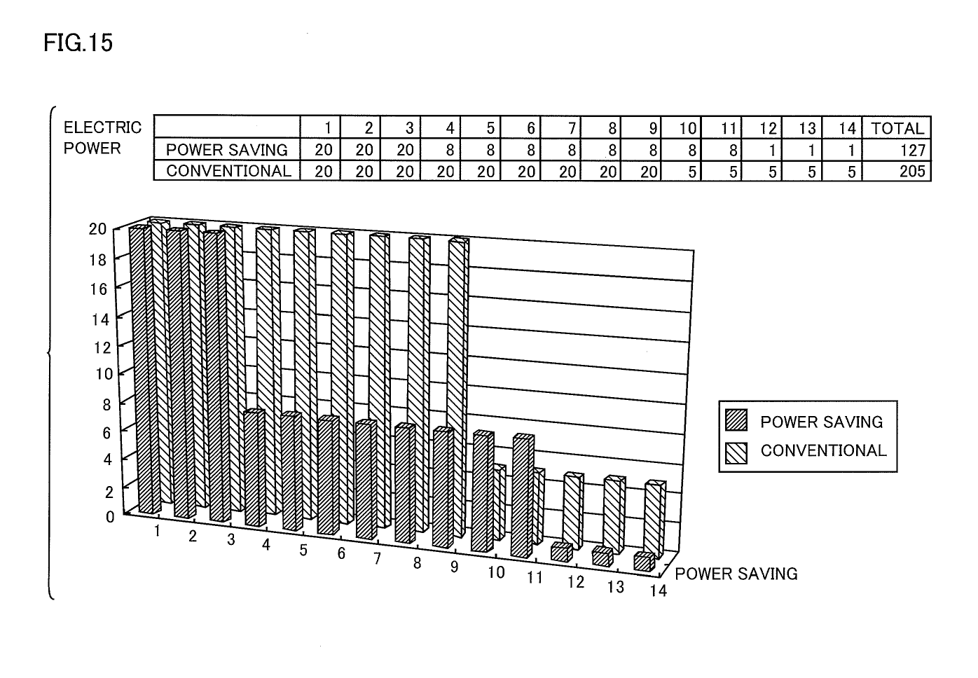

FIG. 15 shows a specific example of a power saving effect achieved by controller unit 150 when the process in FIG. 14 is performed.

“Power saving” in the figure shows power consumption in the RIP process in the case where the process in FIG. 14(B) is performed. “Conventional” in the figure shows power consumption in the RIP process in the case where the process in FIG. 14(A) is performed.

Referring to the figure, in the “conventional” process, it is assumed that the power consumption in controller unit 150 is “20” per unit time in the period until the time “9” during which the RIP process is performed, and that the power consumption in controller unit 150 is “5” in the following period until time “14” during which only printing is done. Here, the power consumption only in controller unit 150 is shown and the power consumption in printer unit 405 is not included. Therefore, the value of power consumption (“20”) until time “3” at which printing is started is equal to the value of power consumption (“20”) from time “3” at which printing is started to time “9.”

Although the RIP process is finished at time “9,” the CPU and the memory bus in controller unit 150 continue to operate at a similar speed as before time “9.” Therefore, the power consumption in controller unit 150 does not become “0.” Here, the power consumption in controller unit 150 after time “9” is “5.”

When the “power saving” process is performed, controller unit 150 consumes power of “20” in each unit of time until time “3” during which time the RIP process for the first page is performed, similarly to the “conventional” process, as shown in the processing in step S301 in FIG. 11. In the subsequent processing until time “11,” the CPU operating frequency is changed to ½, and the CPU power supply voltage is changed to ¾ in controller unit 150. As a result, the power consumption per unit time is “8” from time “3” to time “11,” and the total power consumption from time “3” to time “11” can be reduced to “64” as compared with the conventional “130.” The clock frequency of the CPU in controller unit 150 remains low from time “11” at which the RIP process is finished to time “14,” so that the power consumption of controller unit 150 can be reduced to “1.”

Accordingly, as can be seen in the “total” field in FIG. 15, the total power consumption, which is “205” in the “conventional” process, can be reduced to “127.”

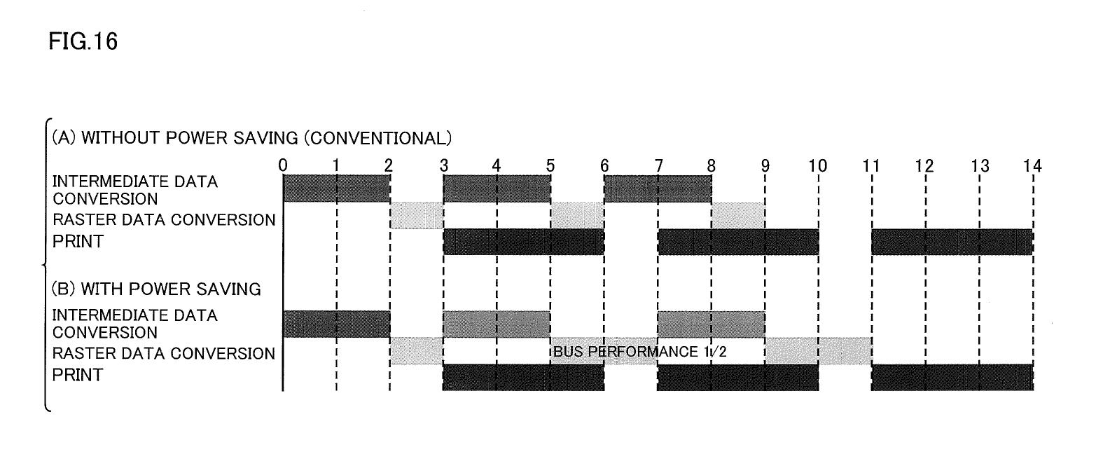

FIG. 16 is a timing chart schematically showing a third process executed by the image forming apparatus in the second embodiment of the present invention.

FIG. 16 shows the time in which the RIP process is performed and the time in which printing is performed, in a case where a three-page image is printed. As the time in which the RIP process is performed, there are shown the conversion time of print data into intermediate data and the conversion time of intermediate data into raster data. The horizontal axis shows the elapsed time since the start of the process and shows the process which is performed in 14 units of time from time “0” to time “14.”

FIG. 16(A) shows the conventional process without power saving, and FIG. 16(B) shows the process in the present embodiment with power saving.

As shown in FIG. 16(A), in the conventional process without power saving, conversion of print data into intermediate data for the first page is performed from time “0” to time “2.” Conversion of intermediate data into raster data for the first page is performed from time “2” to time “3.” Conversion of print data into intermediate data for the second page is performed from time “3” to time “5.” Conversion of intermediate data into raster data for the second page is performed from time “5” to time “6.” Conversion of print data into intermediate data for the third page is performed from time “6” to time “8.” Conversion of intermediate data into raster data for the third page is performed from time “8” to time “9.”

Printing of raster data of the first page is started at time “3” and finished at time “6.” Thereafter, a print interval time is provided from time “6” to time “7.” Printing of raster data of the second page is started at time “7” and finished at time “10.” Thereafter, a print interval time is provided from time “10” to time “11.” Printing of raster data of the third page is started at time “11” and finished at time “14.”

In this manner, it is assumed that the conversion time of print data into intermediate data for one page is two units of time, and that the conversion time of intermediate data into raster data is one unit of time. Immediately when conversion into raster data for the first page is completed, conversion of print data into intermediate data for the second page is started. Simultaneously with the start of conversion of print data into intermediate data for the second page, printing of print data of the first page is started. Printing of an image of one page requires a total of four units of time including three units of time in the hatched portion in the figure and one unit time of interval time.

In other words, the RIP time (the total time of the conversion time into intermediate data and the conversion time from intermediate data into raster data) is ¾ of the print time. The conversion time of print data into intermediate data is ½ of the print time. The conversion time of intermediate data into raster data is ¼ of the print time.

A description will now be given as to the case where the same data as in the conventional process without power saving in FIG. 16(A) is processed by the image forming apparatus in the present embodiment.

In the process with power saving in the present embodiment, the RIP process for the first sheet in step S301 in FIG. 11 is performed in the usual operation. Specifically, conversion of print data into intermediate data for the first page is performed from time “0” to time “2.” Conversion of intermediate data into raster data for the first page is performed from time “2” to time “3.” Printing of raster data of the first page is started at time “3” and finished at time “6.” Thereafter, a print interval time is provided from time “6” to time “7.”

When the RIP process for the first page is completed, in step S303, CPU 201 measures the time (T1) taken to convert print data into intermediate data and the time (T2) taken to convert intermediate data into raster data in the RIP process for the first page.

Then, in step S305, it is determined whether the time (T1) taken to convert print data into intermediate data as measured in step S303 is equal to or smaller than the threshold value (X) for evaluating the time taken to convert print data into intermediate data. Here, the threshold value (X) is ¼ of the time required for printer unit 405 to print one sheet (four units of time including the interval time). Therefore, in step S305, the determination is NO, and the process of reducing the CPU operating frequency and the CPU power supply voltage is not performed.

In step S309, CPU 201 determines whether the time (T2) taken to convert intermediate data into raster data as measured in step S303 is equal to or smaller than the threshold value (Y) for evaluating the time taken to convert intermediate data into raster data. Here, the threshold time (Y) is ¼ of the time required for printer unit 405 to print one sheet (four units of time including the interval time). Therefore, in step S309, the determination is YES, and the operating frequency of the memory bus is reduced to ½, in step S311.

The RIP process of print data of the second page and printing in printer unit 405 are performed in step S313 in the state in which the operating frequency of the memory bus is adjusted. The processing of the third page is performed similarly to the second page.

In this manner, as shown in FIG. 16(B), a process of reducing the speed of conversion into raster data for the second and third pages to ½ is performed. Specifically, in the processing of the second and third pages, the memory bus operating frequency is changed to ½. The RIP process for the first page is performed at the normal speed (the same speed as in FIG. 16(A)), so that a delay in the printing start time of the first page is prevented (step S301 in FIG. 11).

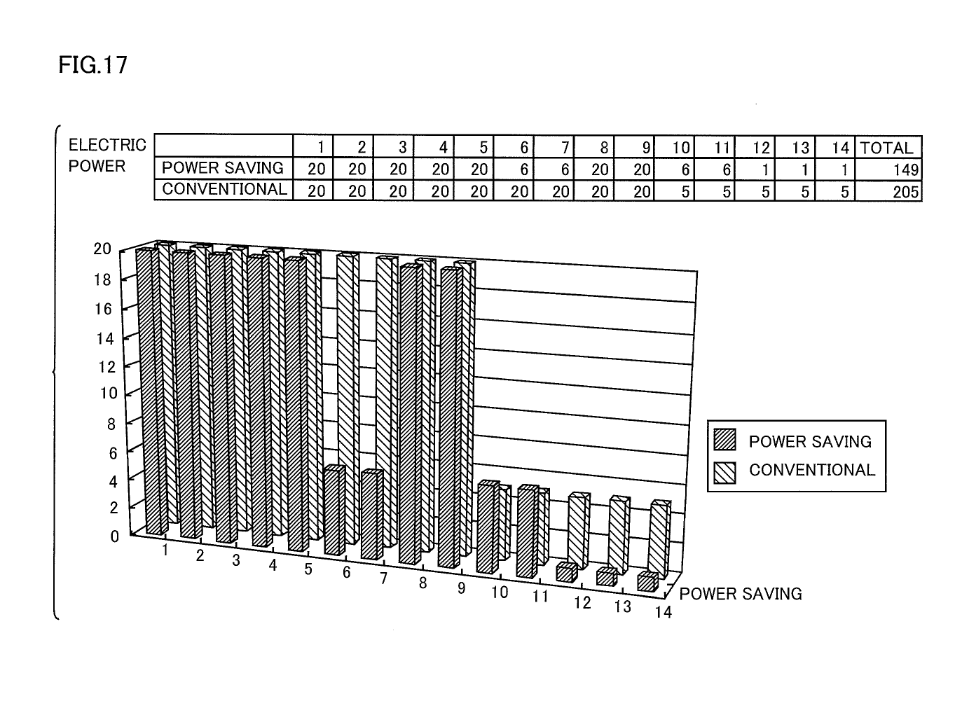

FIG. 17 shows a specific example of a power saving effect achieved by controller unit 150 when the process in FIG. 16 is performed.

“Power saving” in the figure shows power consumption in the RIP process in the case where the process in FIG. 16(B) is performed. “Conventional” in the figure shows power consumption in the RIP process in the case where the process in FIG. 16(A) is performed.

Referring to the figure, in the “conventional” process, it is assumed that the power consumption in controller unit 150 is “20” per unit time in the period until the time “9” during which the RIP process is performed, and that the power consumption in controller unit 150 is “5” in the following period until time “14” during which only printing is done. Here, the power consumption only in controller unit 150 is shown and the power consumption in printer unit 405 is not included. Therefore, the value of power consumption (“20”) until time “3” at which printing is started is equal to the value of power consumption (“20”) from time “3” at which printing is started to time “9.”

Although the RIP process is finished at time “9,” the CPU and the memory bus in controller unit 150 continue to operate at a similar speed as before time “9.” Therefore, the power consumption in controller unit 150 does not become “0.” Here, the power consumption in controller unit 150 after time “9” is “5.”

When the “power saving” process is performed, controller unit 150 consumes power of “20” in each unit of time until time “3” during which time the RIP process for the first page is performed, similarly to the “conventional” process, as shown in the process in step S301 in FIG. 11. In the subsequent processing until time “5,” the CPU operates at a normal speed, so that controller unit 150 consumes power of “20” in each unit of time, similarly to the “conventional” process.

The conversion process of intermediate data into raster data for the second page is performed from time “5.” Here, the memory bus operating frequency in controller unit 150 is changed to ½. Accordingly, the power consumption in each unit of time can be reduced to “6” from time “5” to time “7.” In the subsequent processing until time “9,” the CPU operates at a normal speed, so that controller unit 150 consumes power of “20” in each unit of time, similarly to the “conventional” process. The conversion process into raster data is performed from time “9.” Here, the memory bus operating frequency in controller unit 150 is changed to ½. Therefore, the power consumption from time “9” to “11” is “6.”

The clock frequency of the memory bus in controller unit 150 remains low from time “11” at which the RIP process is finished to time “14,” so that the power consumption of controller unit 150 can be reduced to “1.”

Accordingly, as can be seen in the “total” field in FIG. 17, the total power consumption, which is “205” in the “conventional” process, can be reduced to “149.”

### Third Embodiment

The hardware configuration of the image forming apparatus in a third embodiment is the same as that of the first embodiment, and therefore a description thereof will not be repeated here. In the following, the features of the image forming apparatus in the third embodiment will be described.

The conversion time from intermediate data into raster data varies with the proportion of a printing area in one page. Here, the proportion of printing area is represented, for example, by a ratio of pixels to be drawn to pixels that constitute a one-page image. When no pixel is drawn in one page, the proportion of printing area is 0%. When all the pixels in one page are drawn, the proportion of printing area is 100%.

As an image has a larger proportion of printing area, the amount of data to be processed by controller unit 150 is larger when controller unit 150 converts the image from intermediate data into raster data. Therefore, an image having a large proportion of printing area tends to take a longer time T2 to covert the image from intermediate data into raster data than an image having a small proportion of printing area.

Therefore, the image forming apparatus in the third embodiment controls the operating frequency of the memory bus in accordance with the proportion of printing area in one page. More specifically, when the proportion of printing area in one page is small, it is predicted that the process of converting an image from intermediate data into raster data is completed earlier (the time T2 is shorter), and therefore, the operating frequency of the memory bus is reduced. Accordingly, the speed of converting the image from intermediate data into raster data is slowed down (and power consumption is reduced).

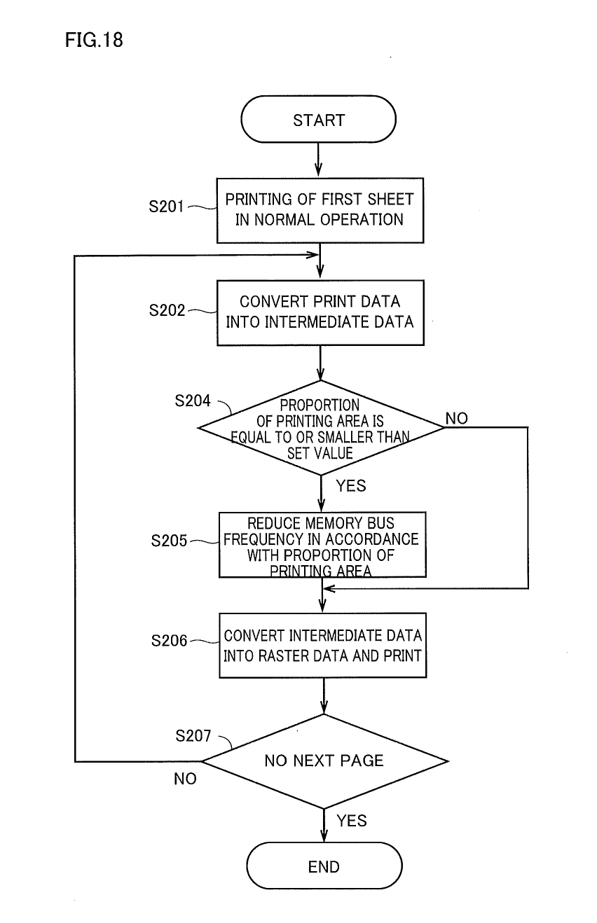

FIG. 18 is a flowchart showing an operation of CPU 201 in the image forming apparatus in the present embodiment.

In this flowchart, the power saving control is performed in accordance with the proportion of printing area.

Referring to the figure, upon starting of a print job, in step S201, CPU 201 performs the RIP process at a normal processing speed without power saving in the printing process for the first page. The time required for this RIP process is measured.

Then, in step S202, print data of the second page is converted into intermediate data. Here, the proportion of printing area of print data of the second page is determined.

In step S204, CPU 201 determines whether the proportion of printing area is equal to or smaller than a prescribed ratio (set value). If YES in step S204, in step S205, a process of reducing the operating frequency of the memory bus is performed in accordance with the proportion of printing area.

More specifically, control is performed such that the operating frequency of the memory bus is lower as the proportion of printing area is smaller. On the other hand, the amount of reduction of the memory bus operating frequency may be set to be constant all the time.

If NO in step S204, the process of reducing the operating frequency of the memory bus is not performed (alternatively, a process of increasing the operating frequency of the memory bus (or restoring to the original one) may be performed).

In step S206, the process of converting intermediate data into raster data for the second page and the printing process are performed under the controlled operating frequency of the memory bus.

In step S207, it is determined whether the processing of the next page is unnecessary. If YES, the process ends. If NO, the processing of the third page is started in step S202.

In this manner, in the present embodiment, when the proportion of printing area is small, the process of reducing the operating frequency of the memory bus is performed. Therefore, power consumption can be reduced.

It is noted that the process in FIG. 18 may be combined with the process in FIG. 7 or FIG. 11. Specifically, the operating frequency of the memory bus may be reduced based on the measured value of conversion time from intermediate data into raster data and on the proportion of printing area. More specifically, the operating frequency of the memory bus in the RIP process of a certain page is determined based on both of the proportion of printing area of that page and the measured value of conversion time from intermediate data into raster data up to the immediately preceding page.

### Effects in Embodiments

As described above, the image processing apparatus in the present embodiment includes a CPU operating frequency control unit capable of reducing the CPU operating frequency of the image processing apparatus, a bus operating frequency control unit capable of reducing the memory bus operating frequency, and a RIP time measuring unit for measuring the RIP time. When the RIP process is too fast, at least one of the CPU operating frequency and the bus operating frequency is reduced in order to make the RIP speed closer to the print speed.

In the present embodiment, when the speed of the RIP process is too fast, the process of reducing the processing capacity of the CPU and the memory is performed. This can reduce power consumed in the print time. On the other hand, it is prevented that the speed of the RIP process becomes too slow, as in the case when NO in step S103 in FIG. 7 (when the speed of the RIP process becomes too slow, the speed is increased), thereby preventing slowing down of the print speed.

In the processing of the first page, the control of reducing the CPU operating frequency and the bus operating frequency is desirably not performed since the fast print time is a high priority (step S101 in FIG. 7, step S201 in FIG. 18).

### [Others]

In the foregoing embodiments, the image processing apparatus controlling both of (1) the CPU operating frequency and (2) the memory bus operating frequency has been described. However, the image processing apparatus may control only one of (1) and (2). Such an image processing apparatus can also save power consumption as compared with the conventional technique. Furthermore, in the foregoing embodiments, the image processing apparatus controlling the CPU power supply voltage together with the CPU operating frequency has been described. However, the image processing apparatus may control only one of the CPU operating frequency and the CPU power supply voltage.

The image forming apparatus may be any one of monochrome/color copiers, a printer, a facsimile machine, and a combination thereof (MFP).

The image forming apparatus may form images on paper not only by electrophotography but by an inkjet method.

The memory for use in the RIP process of processing print data may be any storage device such as an SDRAM, a DRAM, or a hard disk.

A program executing the processing in the foregoing embodiments may be provided. A recording medium such as a CD-ROM, a flexible disk, a hard disk, a ROM, a RAM, or a memory card encoded with the program may be provided to users. The processing illustrated above in the flowcharts and texts is executed by a CPU in accordance with the program. The program may be downloaded to the apparatus through a communication line such as the Internet.

With the configuration as described above, the image processing apparatus can perform the process of converting print data into raster data and measure the time required for the conversion. The setting for slowing down the conversion process is made based on the measurement result. Such a configuration can effectively reduce the speed of the conversion process. Thus, it is possible to provide an image processing apparatus capable of performing an effective power saving process, a method of controlling the image processing apparatus, and a program for controlling the image processing apparatus.

With the configuration as described above, the image processing apparatus can measure the proportion of printing area in print data. The setting for reducing the bus operating frequency is made based on the measurement result. Such a configuration can effectively reduce the bus operating frequency. Thus, it is possible to provide an image processing apparatus capable of performing an effective power saving process, a method of controlling the image processing apparatus, and a program for controlling the image processing apparatus.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
an input unit for inputting print data;
a conversion unit for converting said print data into raster data;
a measuring unit for measuring a time required for conversion in said conversion unit; and
a setting unit for making setting for slowing down a speed of conversion processing in said conversion unit, based on a measurement result obtained by said measuring unit.

2. The image processing apparatus according to claim 1, wherein said conversion unit is configured with a processor and executes a process of converting said print data into intermediate data and a process of converting said intermediate data into raster data, further comprising:
a memory for storing intermediate data converted by said processor; and
a bus for transferring data between said processor and said memory,
wherein said measuring unit measures a time required for converting said print data into intermediate data and a time required for converting said intermediate data into raster data.

3. The image processing apparatus according to claim 2, wherein said setting unit makes at least one of setting of reducing an operating frequency of said processor and setting of reducing a power supply voltage of said processor, based on said measured time required for converting said print data into intermediate data.

4. The image processing apparatus according to claim 3, wherein said setting unit makes at least one of setting of reducing an operating frequency of said processor step by step and setting of reducing a power supply voltage of said processor step by step, based on said measured time required for converting said print data into intermediate data.

5. The image processing apparatus according to claim 2, wherein said setting unit makes setting of reducing an operating frequency of said bus, based on said measured time required for converting said intermediate data into raster data.

6. The image processing apparatus according to claim 5, wherein said setting unit makes setting of reducing an operating frequency of said bus step by step, based on said measured time required for converting said intermediate data into raster data.

7. The image processing apparatus according to claim 2, wherein
said measuring unit measures a time concerning conversion of print data of one page into raster data, and
said setting unit can make setting for reducing at least one of an operating frequency of said processor, a power supply voltage of said processor, and an operating frequency of said bus in processing of a page following said measured page.

8. The image processing apparatus according to claim 1, wherein when a process of converting said print data into raster data is faster than a prescribed speed, said setting unit makes setting of slowing down a speed of the process of converting said print data into raster data.

9. The image processing apparatus according to claim 1, wherein when processing of a first page is performed, said setting unit does not slow down a speed of conversion processing in said conversion unit.

10. An image processing apparatus comprising:
an input unit for inputting print data;
a processor for executing a process of converting said print data into intermediate data and a process of converting said intermediate data into raster data;
a memory for storing said intermediate data converted by said processor;
a bus for transferring data between said processor and said memory;
a measuring unit for measuring a proportion of printing area in said print data; and
a setting unit for making setting for reducing an operating frequency of said bus, based on a measurement result obtained by said measuring unit.

11. An image forming apparatus comprising:
the image processing apparatus of claim 1; and
a printer unit for printing an image based on print data converted by said image processing apparatus.

12. A method of controlling an image processing apparatus comprising:
an input step of inputting print data;
a conversion step of converting said print data into raster data;
a measuring step of measuring a time required for conversion in said conversion step; and
a setting step of making setting for slowing down a speed of conversion processing in said conversion step, based on a measurement result obtained by said measuring step.

13. The method of controlling an image processing apparatus according to claim 12, wherein
said image processing apparatus includes a processor, a memory for storing intermediate data converted by said processor, and a bus for transferring data between said processor and said memory,
said conversion step is executed by said processor, said processor executing a process of converting said print data into intermediate data and a process of converting said intermediate data into raster data,
said measuring step measures a time required for converting said print data into intermediate data and a time required for converting said intermediate data into raster data,
said measuring step measures a time concerning conversion of print data of one page into raster data, and
said setting step makes setting for reducing at least one of an operating frequency of said processor, a power supply voltage of said processor, and an operating frequency of said bus in processing of a page following said measured page.

14. A method of controlling an image processing apparatus including a processor for executing a process of converting print data into intermediate data and a process of converting said intermediate data into raster data, a memory for storing intermediate data converted by said processor, and a bus for transferring data between said processor and said memory, said method comprising:
an input step of inputting said print data;
a measuring step of measuring a proportion of printing area in said print data; and
a setting step of making setting for reducing an operating frequency of said bus, based on a measurement result obtained by said measuring step.

15. A program for controlling an image processing apparatus, said program being stored in a computer-readable medium to cause a computer to execute processing comprising the steps of:
an input step of inputting print data;
a conversion step of converting said print data into raster data;
a measuring step of measuring a time required for conversion in said conversion step; and
a setting step of making setting for slowing down a speed of conversion processing in said conversion step, based on a measurement result obtained by said measuring step.

16. The program for controlling an image processing apparatus according to claim 15, wherein
said image processing apparatus includes a processor, a memory for storing intermediate data converted by said processor, and a bus for transferring data between said processor and said memory,
said conversion step is executed by said processor, said processor executing a process of converting said print data into intermediate data and a process of converting said intermediate data into raster data,
said measuring step measures a time required for converting said print data into intermediate data and a time required for converting said intermediate data into raster data,
said measuring step measures a time concerning conversion of print data of one page into raster data, and
said setting step makes setting for reducing at least one of an operating frequency of said processor, a power supply voltage of said processor, and an operating frequency of said bus in processing of a page following said measured page.

17. A program for controlling an image processing apparatus including a processor for executing a process of converting print data into intermediate data and a process of converting said intermediate data into raster data, a memory for storing intermediate data converted by said processor, and a bus for transferring data between said processor and said memory, said program being stored in a computer-readable medium to cause a computer to execute processing comprising the steps of:
an input step of inputting said print data;
a measuring step of measuring a proportion of printing area in said print data; and
a setting step of making setting for reducing an operating frequency of said bus, based on a measurement result obtained by said measuring step.
